(19) United States
(12) Patent Application Publication
(10) Pub. No.: US 2025/0343909 A1
(43) Pub. Date: Nov. 6, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Junru LI, Beijing (CN); Kai ZHANG, Los Angeles, CA (US); Chaoyi LIN, Beijing (CN); Yue LI, Los Angeles, CA (US); Li ZHANG, Los Angeles, CA (US)

(21) Appl. No.: 19/268,671

(22) Filed: Jul. 14, 2025

Related U.S. Application Data
(63) Continuation of application No. PCT/CN2024/071700, filed on Jan. 10, 2024.

(30) Foreign Application Priority Data
Jan. 12, 2023 (WO) PCT/CN2023/071909

(51) Int. Cl. H04N 19/117; H04N 19/70; H04N 19/80

(52) U.S. Cl. CPC H04N 19/117; H04N 19/70; H04N 19/80

(57) ABSTRACT

Embodiments of the disclosure provide a solution for video processing. A method for video processing is proposed. The method comprises: applying, for a conversion between a video unit of a video and a bitstream of the video, a neural network (NN) filter to the video unit, wherein the NN filter comprises a set of sub-modules, at least one of: the set of sub-modules, inputs of the set of sub-modules, or outputs of the set of sub-modules is selectable; and performing the conversion based on the NN filter.

### CROSS REFERENCE

This application is a continuation of International Application No. PCT/CN2024/071700, filed on Jan. 10, 2024, which claims the benefits of International Application No. PCT/CN2023/071909, filed on Jan. 12, 2023. The entire contents of these applications are hereby incorporated by reference in their entireties.

### FIELDS

Embodiments of the present disclosure relates generally to video processing techniques, and more particularly, to separable neural network-based filters for image/video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: applying, for a conversion between a video unit of a video and a bitstream of the video, a neural network (NN) filter to the video unit, wherein the NN filter comprises a set of sub-modules, at least one of: the set of sub-modules, inputs of the set of sub-modules, or outputs of the set of sub-modules is selectable; and performing the conversion based on the NN filter. In this way, it can avoid storage overhead.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: applying a neural network (NN) filter to a video unit of the video, wherein the NN filter comprises a set of sub-modules, at least one of: the set of sub-modules, inputs of the set of sub-modules, or outputs of the set of sub-modules is selectable; and generating a bitstream of the video based on the NN filter.

In a fifth aspect, a method for storing a bitstream of a video is proposed. The method comprises: applying a neural network (NN) filter to a video unit of the video, wherein the NN filter comprises a set of sub-modules, at least one of: the set of sub-modules, inputs of the set of sub-modules, or outputs of the set of sub-modules is selectable; generating a bitstream of the video based on the NN filter; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing an example of raster-scan slice partitioning of a picture;

FIG. 5 illustrates an example diagram showing an example of rectangular slice partitioning of a picture;

FIG. 6 illustrates an example diagram showing an example of a picture partitioned into tiles, bricks, and rectangular slices;

FIG. 7A illustrates an example diagram showing CTBs crossing the bottom picture border;

FIG. 7B illustrates an example diagram showing CTBs crossing the right picture border;

FIG. 7C illustrates an example diagram showing CTBs crossing the right bottom picture border;

FIG. 8 illustrates an example diagram showing an example of encoder block diagram;

FIG. 9 illustrates an example diagram showing an illustration of picture samples and horizontal and vertical block boundaries on the 8×8 grid, and the nonoverlapping blocks of the 8×8 samples;

FIG. 10 illustrates an example diagram showing pixels involved in filter on/off decision and strong/weak filter selection;

FIGS. 11A-11D illustrate example diagrams showing four 1-D directional patterns for EO sample classification;

FIGS. 12A-12C illustrate example diagrams showing examples of GALF filter shapes;

FIGS. 13A-13C illustrate example diagrams showing examples of relative coordinator for the 5×5 diamond filter support;

FIG. 14 illustrates an example diagram showing examples of relative coordinates for the 5×5 diamond filter support;

FIG. 15A illustrates an example diagram showing Architecture of the proposed CNN filter;

FIG. 15B illustrates an example diagram showing a construction of ResBlock (residual block) in the CNN filter;

FIG. 16 shows a basic network structure of neural network based in-loop filter;

FIG. 17 shows a modified network structure of neural network based in-loop filter;

FIG. 18 illustrates a flowchart of a method for video processing in accordance with embodiments of the present disclosure; and

FIG. 19 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

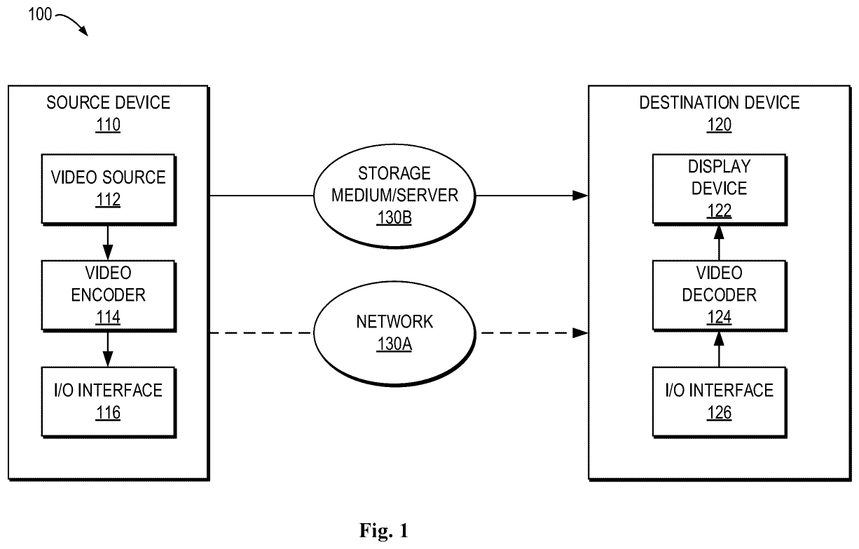

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

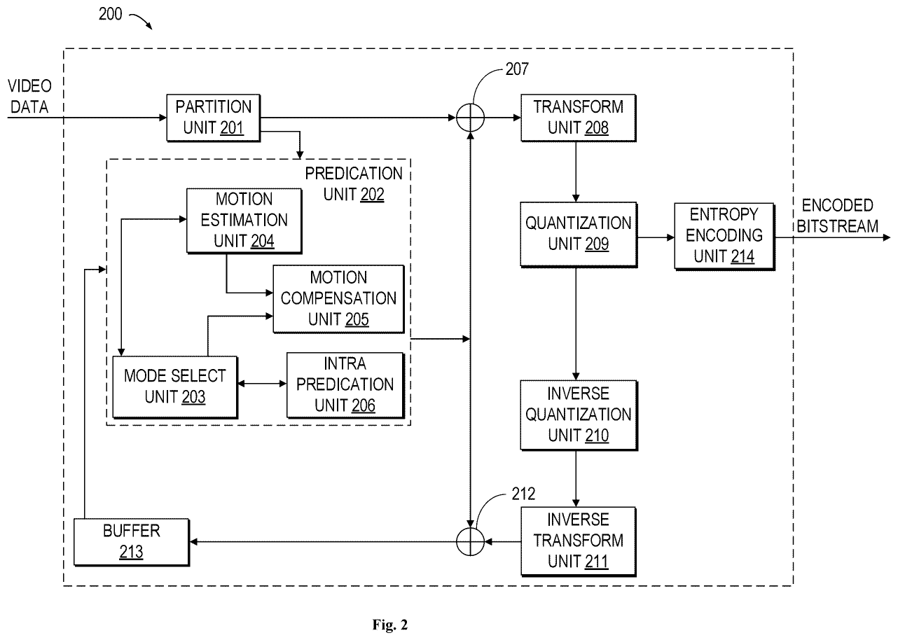

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

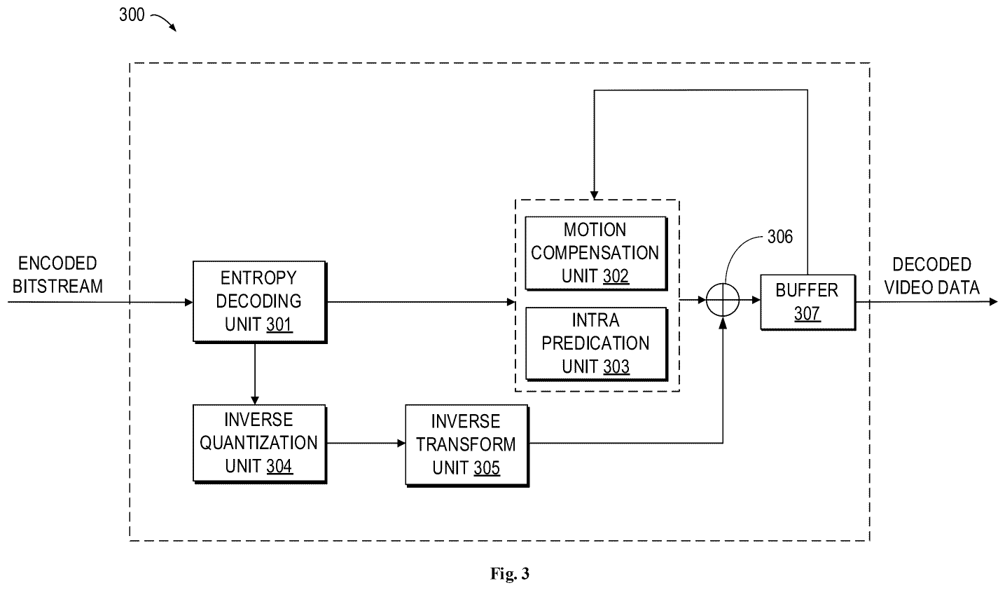

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is related to the loop filter in image/video coding. It may be applied to the existing video coding standard like High-Efficiency Video Coding (HEVC), Versatile Video Coding (VVC), or the standard (e.g., AVS3) to be finalized. It may be also applicable to future video coding standards or video codec or being used as post-processing method which is out of encoding/decoding process.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure where temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

The latest version of VVC draft, i.e., Versatile Video Coding (Draft 10) could be found at: http://phenix.it-sudparis.eu/jvet/doc_end_user/current_document.php?id=10399.

The latest reference software of VVC, named VTM, could be found at: https://vegit.hhi.fraunhofer.de/jvet/VVCSoftware_VTM/-/tags/VTM-10.0.

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space. For video compression, the most frequently used color spaces are YCbCr and RGB. YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

The two chroma components are sampled at half the sample rate of luma: the horizontal chroma resolution is halved. This reduces the bandwidth of an uncompressed video signal by one-third with little to no visual difference.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a tile.

A slice either contains a number of tiles of a picture or a number of bricks of a tile.

Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

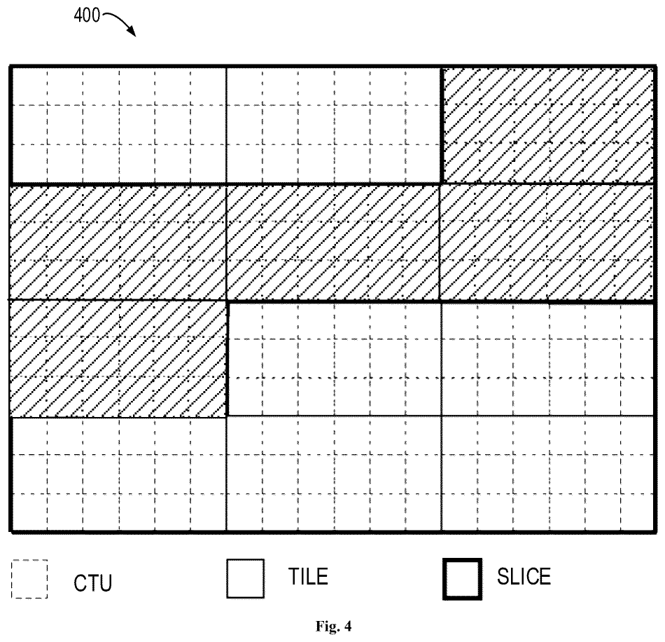

FIG. 4 illustrates an example diagram 400 showing an example of raster-scan slice partitioning of a picture. In FIG. 4, the picture is divided into 12 tiles and 3 raster-scan slices. The picture in FIG. 4 with 18 by 12 luma CTUs is partitioned into 12 tiles and 3 raster-scan slices (informative).

FIG. 5 illustrates an example diagram 500 showing an example of rectangular slice partitioning of a picture. In FIG. 5, the picture is divided into 24 tiles (6 tile columns and 4 tile rows) and 9 rectangular slices. The picture in FIG. 5 with 18 by 12 luma CTUs is partitioned into 24 tiles and 9 rectangular slices (informative).

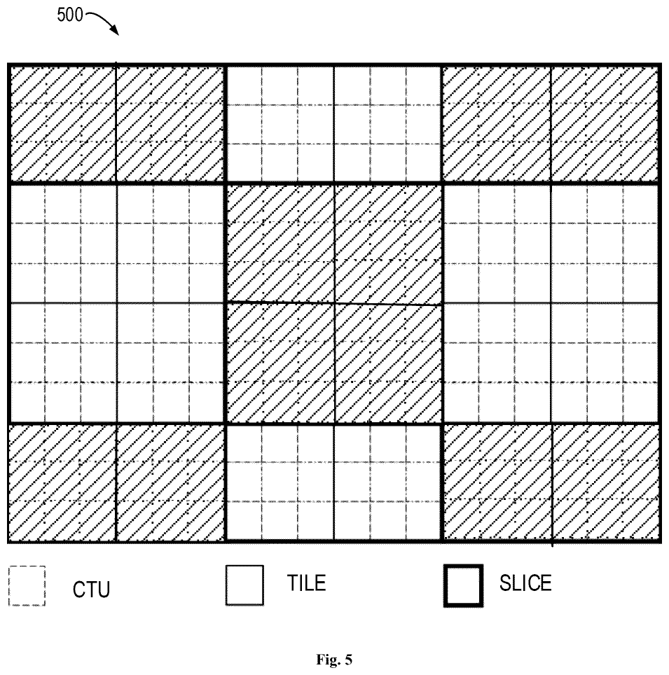

FIG. 6 illustrates an example diagram 600 showing an example of a picture partitioned into tiles, bricks, and rectangular slices. In FIG. 6, the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. The picture in FIG. 6 is partitioned into 4 tiles, 11 bricks, and 4 rectangular slices (informative).

### 2.2.1. CTU/CTB Sizes

In VVC, the CTU size, signaled in SPS by the syntax element log2_ctu_size_minus2, could be as small as 4×4.

### 7.3.2.3 Sequence Parameter Set RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc == 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rp10_flag ? 2 : 1; i++ ) { | |
| num_ref_pic_lists_in_sps[ i ] | ue(v) |
| for( j = 0; j < num_ref_pic_lists_in_sps[ i ]; j++ ) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| . . . | |
| rbsp_trailing_bits( ) | |
| } | |

log2_ctu_size_minus2 plus 2 specifies the luma coding tree block size of each CTU.

log2_min_luma_coding_block_size_minus2 plus 2 specifies the minimum luma coding block size.

The variables CtbLog2SizeY, CtbSizeY, MinCbLog2SizeY, MinCbSizeY, MinThLog2SizeY, MaxTbLog2SizeY, MinTbSizeY, MaxTbSizeY, PicWidthlnCtbsY, PicHeightlnCtbsY, PicSizelnCtbsY, PicWidthlnMinCbsY, PicHeightlnMinCbsY, PicSizelnMinCbsY, PicSizelnSamplesY, PicWidthInSamplesC and PicHeightlnSamplesC are derived as follows:

$$Ctb Log 2 Size Y = log 2 \_ctu \_size \_minus 2 + 2 \qquad ( 7 - 9 )$$

$$Ctb Size Y = 1 ≪ Ctb Log 2 Size Y \qquad ( 7 - 10 )$$

$$MidCb Log 2 Size Y = log 2 \_min \_luma \_coding \_block \_size \_minus 2 + 2 \qquad ( 7 - 11 )$$

$$Min Cb Size Y = 1 ≪ Min Cb Log 2 Size Y \qquad ( 7 - 12 )$$

$$Min Tb Log 2 SizeY = 2 \qquad ( 7 - 13 )$$

$$Max Tb Log 2 Size Y = 6 \qquad ( 7 - 14 )$$

$$Min Tb Size Y = 1 ≪ Min Tb Log 2 Size Y \qquad ( 7 - 15 )$$

$$Max Tb Size Y = 1 ≪ Max Tb Log 2 Size Y \qquad ( 7 - 16 )$$

$$Pic WidthIn CtbsY = Ceil ( pic\_width \_in \_luma \_samples \div Ctb Size Y ) \qquad ( 7 - 17 )$$

$$Pic HeightIn CtbY = Ceil ( pic\_height \_in \_luma \_samples \div Ctb Size Y ) \qquad ( 7 - 18 )$$

$$Pic SizeIn CtbsY = Pic WidthIn CtbsY * Pic HeightIn CtbsY \qquad ( 7 - 19 )$$

$$Pic WidthIn Min CbsY = pic\_width \_in \_luma \_samples / Min Cb Size Y \qquad ( 7 - 20 )$$

$$Pic HeightIn Min CbsY = pic\_height \_in \_luma \_samples / Min Cb Size Y \qquad ( 7 - 21 )$$

$$Pic SizeIn Min CbsY = Pic WidthIn Min CbsY * Pic HeightIn Min CbsY \qquad ( 7 - 22 )$$

$$Pic SizeInSamples Y = pic\_width \_in \_luma \_samples * pic\_height \_inb \_luma \_samples \qquad ( 7 - 23 )$$

$$Pic WidthInSamples C = pic\_width \_in \_luma \_samples / Sub Width C \qquad ( 7 - 24 )$$

$$Pic HeightInSamples C = pic\_height \_iin \_luma \_samples / Sub Height C . \qquad ( 7 - 25 )$$

### 2.2.2. TUs in a Picture

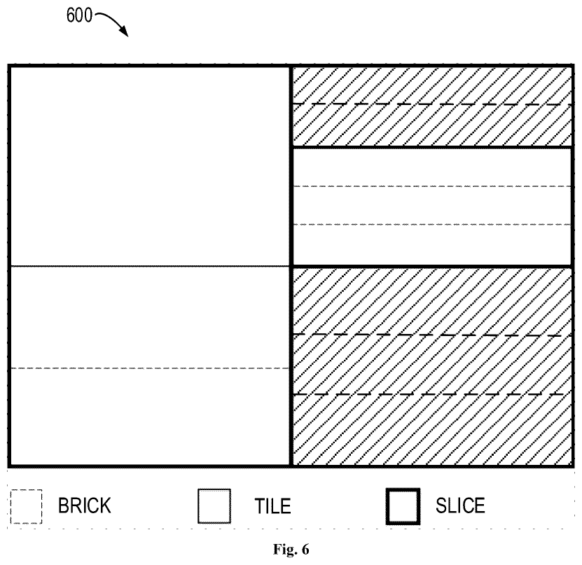

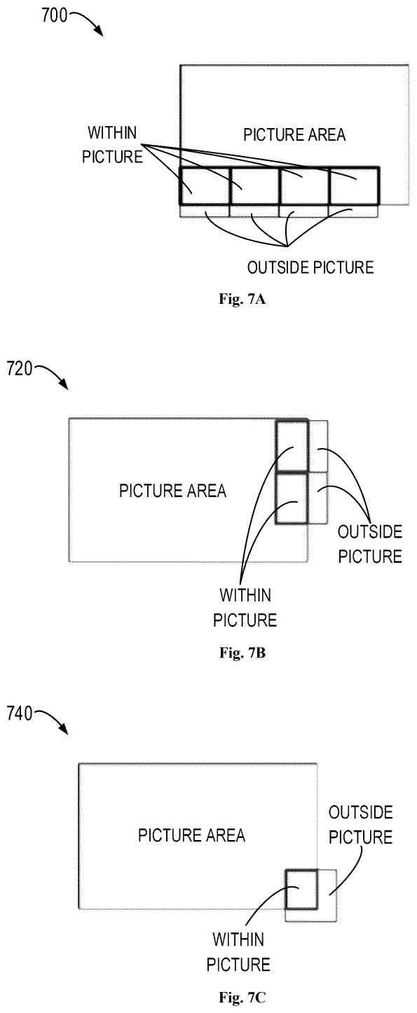

Suppose the CTB/LCU size indicated by M×N (typically M is equal to N, as defined in HEVC/VVC), and for a CTB located at picture (or tile or slice or other kinds of types, picture border is taken as an example) border, K×L samples are within picture border where either K<M or L<N. FIG. 7A illustrate an example diagram 700 showing CTBs crossing the bottom picture border, in which K=M, L<N. FIG. 7B illustrates an example diagram 720 showing CTBs crossing the right picture border, in which K<M, L=N. FIG. 7C illustrates an example diagram 740 showing CTBs crossing the right bottom picture border, in which K<M, L<N. For those CTBs as depicted in FIGS. 7A-7C, the CTB size is still equal to M×N, however, the bottom boundary/right boundary of the CTB is outside the picture.

### 2.3. Coding Flow of a Typical Video Codec

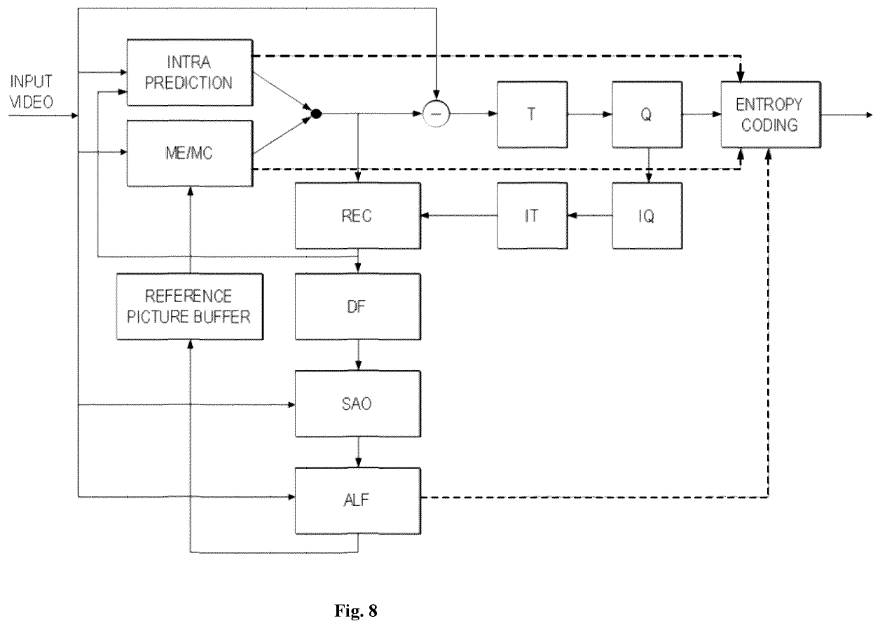

FIG. 8 illustrates an example diagram 800 showings an example of encoder block diagram of VVC, which contains three in-loop filtering blocks: deblocking filter (DF) 805, sample adaptive offset (SAO) 806 and ALF 807. Unlike DF 805, which uses predefined filters, SAO 806 and ALF 807 utilize the original samples of the current picture to reduce the mean square errors between the original samples and the reconstructed samples by adding an offset and by applying a finite impulse response (FIR) filter, respectively, with coded side information signaling the offsets and filter coefficients. ALF 807 is located at the last processing stage of each picture and can be regarded as a tool trying to catch and fix artifacts created by the previous stages.

### 2.4. Deblocking Filter (DB)

The input of DB is the reconstructed samples before in-loop filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

FIG. 9 illustrates an example diagram 900 showing an illustration of picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filtered and the setting of bS[xDᵢ][yDⱼ] (where [xDᵢ][yDⱼ] denotes the coordinate) for this edge is defined in Table 1 and Table 2, respectively.

TABLE 1
Boundary strength (when SPS IBC is disabled)

| Pri- | | | | |
|---|---|---|---|---|
| ority | Conditions | Y | U | V |
| 5 | At least one of the adjacent blocks is intra | 2 | 2 | 2 |
| 4 | TU boundary and at least one of the | 1 | 1 | 1 |
| | adjacent blocks has non-zero transform | | | |
| | coefficients | | | |
| 3 | Reference pictures or number of MVs (1 for | 1 | N/A | N/A |
| | uni-prediction, 2 for bi-prediction) of the | | | |
| | adjacent blocks are different | | | |
| 2 | Absolute difference between the motion vectors | 1 | N/A | N/A |
| | of same reference picture that belong to the | | | |
| | adjacent blocks is greater than or equal to | | | |
| | one integer luma sample | | | |
| 1 | Otherwise | 0 | 0 | 0 |

TABLE 2
Boundary strength (when SPS IBC is enabled)

| Pri- | | | | |
|---|---|---|---|---|
| ority | Conditions | Y | U | V |
| 8 | At least one of the adjacent blocks is intra | 2 | 2 | 2 |
| 7 | TU boundary and at least one of the adjacent | 1 | 1 | 1 |
| | blocks has non-zero transform coefficients | | | |
| 6 | Prediction mode of adjacent blocks is | 1 | | |
| | different (e.g., one is IBC, one is inter) | | | |
| 5 | Both IBC and absolute difference between the | 1 | N/A | N/A |
| | motion vectors that belong to the adjacent | | | |
| | blocks is greater than or equal to one | | | |
| | integer luma sample | | | |
| 4 | Reference pictures or number of MVs (1 for | 1 | N/A | N/A |
| | uni-prediction, 2 for bi-prediction) of the | | | |
| | adjacent blocks are different | | | |
| 3 | Absolute difference between the motion vectors | 1 | N/A | N/A |
| | of same reference picture that belong to the | | | |
| | adjacent blocks is greater than or equal to | | | |
| | one integer luma sample | | | |
| 1 | Otherwise | 0 | 0 | 0 |

### 2.4.3. Deblocking Decision for Luma Component

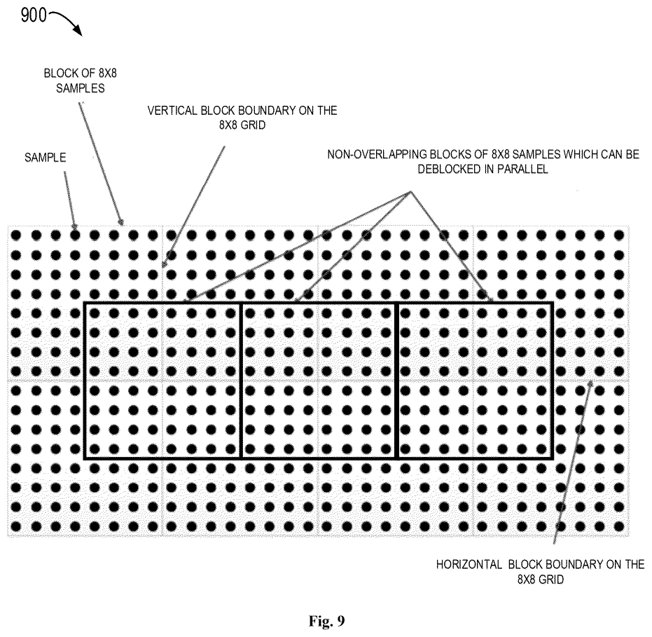

The deblocking decision process is described in this sub-section. FIG. 10 illustrates an example diagram 1000 showing pixels involved in filter on/off decision and strong/weak filter selection.

Wider-stronger luma filter is filters are used only if all the Condition1, Condition2 and Condition 3 are TRUE. The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

$$\begin{matrix}b Side Pis Large Blk = ( ( edge type is vertical and {p}_{0} belongs to CU with width >= 32 ) \vert \vert ( edge type is horizontal and {p}_{0} belongs to CU with height >= 32 ) ) ? TRUE : FLASE \\ b Side Q isLarge Blk = ( ( edge type is vertical and {q}_{0} belongs to CU with width >= 32 ) \vert \vert ( edge type is horizontal and {q}_{0} belongs to CU with height >= 32 ) ) ? TRUE : FLASE\end{matrix}$$

Based on bSidePisLargeBlk and bSideQisLargeBlk, the condition 1 is defined as follows.

Condition1=(bSidePisLargeBlk∥bSidePisLargeBlk) ? TRUE: FALSE

Next, if Condition 1 is true, the condition 2 will be further checked. First, the following variables are derived:
dp0, dp3, dq0, dq3 are first derived as in HEVC
if (p side is greater than or equal to 32)

$$\begin{matrix}dp 0 = ( dp 0 + Abs ( p {5}_{0} - 2 * p {4}_{0} + p {3}_{0} ) + 1 ) ≫ 1 \\ dp 3 = ( dp 3 + Abs ( p {5}_{3} - 2 * p {4}_{3} + p {3}_{3} ) + 1 ) ≫ 1\end{matrix}$$

if (q side is greater than or equal to 32)

$$\begin{matrix}dq 0 = ( dq 0 + Abs ( q {5}_{0} - 2 * q {4}_{0} + q {3}_{0} ) + 1 ) ≫ 1 \\ dq 3 = ( dq 3 + Abs ( q {5}_{3} - 2 * q {4}_{3} + q {3}_{3} ) + 1 ) ≫ 1.\end{matrix}$$

Condition2=(d<β) ? TRUE: FALSE
where d=dp0+dq0+dp3+dq3.

If Condition1 and Condition2 are valid, whether any of the block sub-blocks is further checked:

```
If (bSidePisLargeBlk)
  {
        If (mode block P == SUBBLOCKMODE)
              Sp =5
          else
              Sp =7
}
else
  Sp = 3
If (bSideQisLargeBlk)
    {
        If (mode block Q == SUBBLOCKMODE)
                Sq =5
            else
                Sq =7
      }
else
    Sq = 3.
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
dpq is derived as in HEVC.
sp₃ = Abs( p₃ − p₀ ), derived as in HEVC
if (p side is greater than or equal to 32)
    if(Sp==5)
      sp₃ = ( sp₃ + Abs( p₅ − p₃ ) + 1) >> 1
    else
      sp₃ = ( sp₃ + Abs( p₇ − p₃ ) + 1) >> 1
sq₃ = Abs( q₀ − q₃ ), derived as in HEVC
if (q side is greater than or equal to 32)
  If(Sq==5)
    sq₃ = ( sq₃ + Abs( q₅ − q₃ ) + 1) >> 1
  else
    sq₃ = ( sq₃ + Abs( q₇ − q₃ ) + 1) >> 1.
```

As in HEVC, StrongFilterCondition=(dpq is less than (β>>2), sp₃+sq₃ is less than (3*β>>5), and Abs(p₀−q₀) is less than (5*t_{C}+1)>>1) ? TRUE:FALSE.

### 2.4.4. Stronger Deblocking Filter for Luma (Designed for Larger Blocks)

Bilinear filter is used when samples at either one side of a boundary belong to a large block. A sample belonging to a large block is defined as when the width >=32 for a vertical edge, and when height >=32 for a horizontal edge.

The bilinear filter is listed below.

Block boundary samples pᵢ for i=0 to Sp−1 and qᵢ for j=0 to Sq−1 (pi and qi are the i-th sample within a row for filtering vertical edge, or the i-th sample within a column for filtering horizontal edge) in HEVC deblocking described above) are then replaced by linear interpolation as follows:

$$\begin{matrix}— {p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i} \\ — {q}_{j}^{′} = ( {g}_{j} * {Middle}_{s , t} + ( 64 - {g}_{j} ) * {Q}_{s} + 32 ) ≫ 6 ) , clipped to {q}_{j} \pm {tcPD}_{j}\end{matrix}$$

where tcPDᵢ and tcPDⱼ term is a position dependent clipping described in Section 2.4.7 and gⱼ, fᵢ, Middle_{s,t}, Pₛ and Qₛ are given below.

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped. Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.

The second condition will be TRUE when d is less than β.

In the third condition StrongFilterCondition is derived as follows:
dpq is derived as in HEVC.

$$\begin{matrix}{sp}_{3} = Abs ( {p}_{3} - {p}_{0} ) , derived as in HEVC . \\ {sq}_{3} = Abs ( {q}_{0} - {q}_{3} ) , derived as in HEVC .\end{matrix}$$

As in HEVC design, StrongFilterCondition=(dpq is less than (β>>2), sp₃+sq₃ is less than (β>>3), and Abs(p₀−q₀) is less than (5*t_{C}+1)>>1).

### 2.4.6. Strong Deblocking Filter for Chroma

The following strong deblocking filter for chroma is defined:

$$\begin{matrix}{p}_{2}^{′} = ( 3 * {p}_{3} + 2 * {p}_{2} + {p}_{1} + {p}_{0} + {q}_{0} + 4 ) ≫ 3 \\ {p}_{1}^{′} = ( 2 * {p}_{3} + {p}_{2} + 2 * {p}_{1} + {p}_{0} + {q}_{0} + {q}_{1} + 4 ) ≫ 3 \\ {p}_{0}^{′} = ( {p}_{3} + {p}_{2} + {p}_{1} + 2 * {p}_{0} + {q}_{0} + {q}_{1} + {q}_{2} + 4 ) ≫ 3.\end{matrix}$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

$$\begin{matrix}Tc 7 = \{ 6 , 5 , 4 , 3 , 2 , 1 , 1 \} ; Tc 3 = \{ 6 , 4 , 2 \} ; \\ tcPD = ( Sp == 3 ) ? Tc 3 : Tc 7 ; \\ tcQD = ( Sq == 3 ) ? Tc 3 : Tc 7.\end{matrix}$$

For the P or Q boundaries being filtered with a short symmetrical filter, position dependent threshold of lower magnitude is applied:

$$Tc 3 = \{ 3 , 2 , 1 \} .$$

Following defining the threshold, filtered p′ᵢ and q′ᵢ sample values are clipped according to tcP and tcQ clipping values:

$$\begin{matrix}{p}_{i}^{″} = Clip 3 ( {p}_{i}^{′} + tc {P}_{i} , {p}_{i}^{′} - tc {P}_{i} , {p}_{i}^{′} ) ; \\ {q}_{j}^{″} = Clip 3 ( {q}_{j}^{′} + tc {Q}_{j} , {q}_{j}^{′} - tc {Q}_{j} , {q}_{j}^{′} ) ;\end{matrix}$$

where p′ᵢ and q′ᵢ are filtered sample values, p″ᵢ and q″ⱼ are output sample value after the clipping and tcPᵢ tcPᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge != 0) {
  if (!(implicitTU && (edge == (64 / 4))))
    if (edge == 2 || edge == (orthogonalLength − 2) || edge == (56 / 4) || edge == (72 / 4))
        Sp = Sq = 2;
      else
        Sp = Sq = 3;
  else
      Sp = Sq = bSideQisLargeBlk ? 5:3
}
```

where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 2.5. SAO

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 135° diagonal, and 45° diagonal.

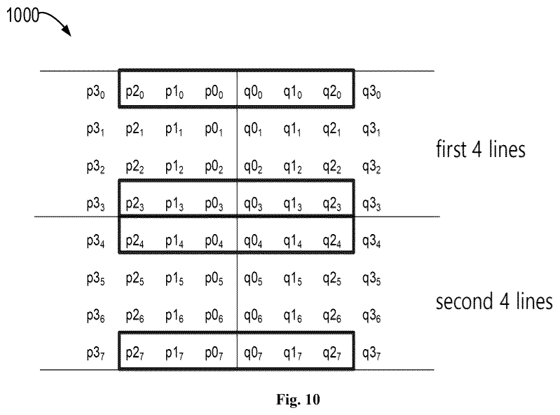

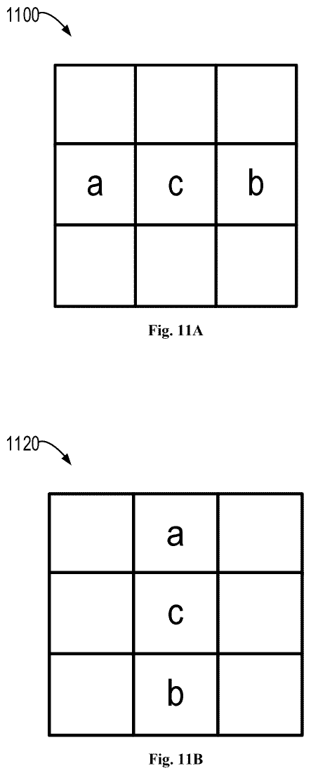

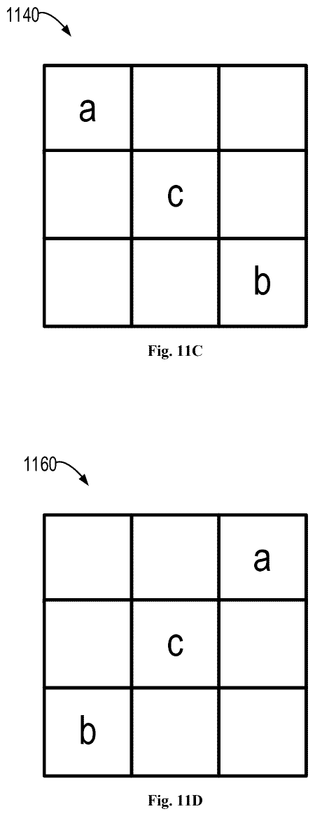

FIG. 11A illustrates an example diagram 1100 showing a 1-D directional pattern for EO sample classification with horizontal (EO class=0). FIG. 11B illustrates an example diagram 1120 showing a 1-D directional pattern for EO sample classification with vertical (EO class=1). FIG. 11C illustrates an example diagram 1140 showing a 1-D directional pattern for EO sample classification with 135° diagonal (EO class=2). FIG. 11D illustrates an example diagram 1160 showing a 1-D directional pattern for EO sample classification with 45° diagonal (EO class=3).

For a given EO class, each sample inside the CTB is classified into one of five categories. The current sample value, labeled as “c,” is compared with its two neighbors along the selected 1-D pattern. The classification rules for each sample are summarized in Table 1. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c < a and c < b |
| 2 | (c < a && c == b) \|\|(c == a && c < b) |
| 3 | (c > a && c == b) \|\|(c == a && c > b) |
| 4 | c > a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.

In the JEM, a geometry transformation-based adaptive loop filter (GALF) with block-based filter adaption is applied. For the luma component, one among 25 filters is selected for each 2×2 block, based on the direction and activity of local gradients.

### 2.6.1. Filter Shape

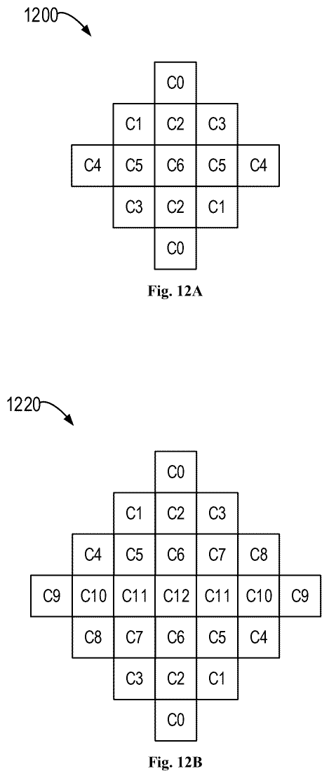

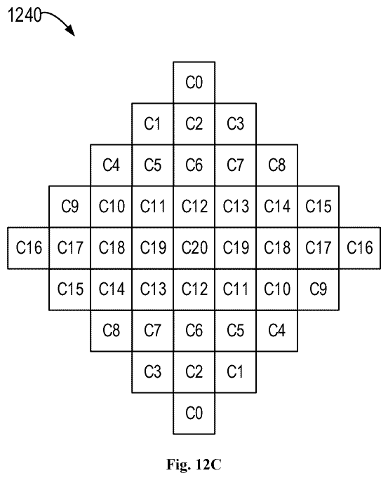

FIG. 12A illustrates an example diagram 1200 showing examples of GALF filter shapes with 5×5 diamond. FIG. 12B illustrates an example diagram 1220 showing examples of GALF filter shapes with 7×7 diamond. FIG. 12C illustrates an example diagram 1240 showing examples of GALF filter shapes with 9×9 diamond. In the JEM, up to three diamond filter shapes (as shown in FIGS. 12A-12C) can be selected for the luma component. An index is signalled at the picture level to indicate the filter shape used for the luma component. Each square represents a sample, and Ci (i being 0-6 (left), 0-12 (middle), 0-20 (right)) denotes the coefficient to be applied to the sample. For chroma components in a picture, the 5×5 diamond shape is always used.

### 2.6.1.1. Block Classification

Each 2×2 block is categorized into one out of 25 classes. The classification index C is derived based on its directionality D and a quantized value of activity A, as follows:

$$C = 5 D + \hat{A} . \qquad ( 1 )$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , 1} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , 1} = \vert 2 R ( k , l ) - R ( k - 1 , l ) - R ( k + 1 , l ) \vert , \qquad ( 3 )$$

$${g}_{d 1} = {\sum }_{k = i - 2}^{i + 3} {\sum }_{l = j - 3}^{j + 3} D {1}_{k , 1} , D {1}_{k , l} = \vert 2 R ( k , l ) - R ( k - 1 , l - 1 ) - R ( k + 1 , l + 1 ) \vert \qquad ( 4 )$$

$${g}_{d 2} = {\sum }_{k = i - 2}^{i + 3} . {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert . \qquad ( 5 )$$

Indices i and j refer to the coordinates of the upper left sample in the 2×2 block and R(i,j) indicates a reconstructed sample at coordinate (i,j).

Then D maximum and minimum values of the gradients of horizontal and vertical directions are set as:

$${g}_{h , ν}^{max} = max ( {g}_{h} , {g}_{v} ) , {g}_{h , v}^{min} = min ( {g}_{h} , {g}_{v} ) , \qquad ( 6 )$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) . \qquad ( 7 )$$

To derive the value of the directionality D, these values are compared against each other and with two thresholds t₁ and t₂:
Step 1. If both

$${g}_{h , ν}^{max} \leq {t}_{1} \cdot {g}_{h , ν}^{min} and {g}_{d 0 , d 1}^{max} \leq {t}_{1} . {g}_{d 0 , d 1}^{min}$$

are true, D is set to 0.
Step 2. If

$${g}_{h , ν}^{max} / {g}_{h , ν}^{min} > {g}_{d 0 , d 1}^{max} / {g}_{d 0 , d 1}^{min} ,$$

continue from Step 3; otherwise continue from Step 4.
Step 3. If

$${g}_{h , ν}^{max} > {t}_{2} \cdot {g}_{h , ν}^{min} ,$$

D is set to 2; otherwise D is set to 1.
Step 4. If

$${g}_{d 0 , d 1}^{max} > {t}_{2} \cdot {g}_{d 0 , d 1}^{min} ,$$

D is set to 4; otherwise D is set to 3.
The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.

For both chroma components in a picture, no classification method is applied, i.e. a single set of ALF coefficients is applied for each chroma component.

### 2.6.1.2. Geometric Transformations of Filter Coefficients

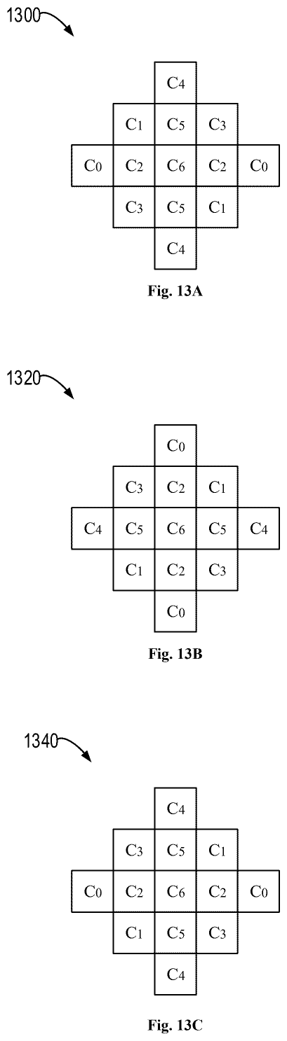

FIG. 13A illustrates an example diagram 1300 showing relative coordinator for the 5×5 diamond filter support (diagonal). FIG. 13B illustrates an example diagram 1320 showing relative coordinator for the 5×5 diamond filter support (vertical flip). FIG. 13C illustrates an example diagram 1340 showing relative coordinator for the 5×5 diamond filter support (rotation).

Before filtering each 2×2 block, geometric transformations such as rotation or diagonal and vertical flipping are applied to the filter coefficients f(k,l), which is associated with the coordinate (k,l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , \qquad ( 9 )$$

$$Vertical flip : {f}_{V} ( k , l ) = f ( k , K - l - 1 ) ,$$

$$Rotation : {f}_{R} ( k , l ) = f ( K - l - 1 , k ) .$$

where K is the size of the filter and 0≤k, l≤K−1 are coefficients coordinates, such that location (0,0) is at the upper left corner and location (K−1, K−1) is at the lower right corner. The transformations are applied to the filter coefficients f(k,l) depending on gradient values calculated for that block. The relationship between the transformation and the four gradients of the four directions are summarized in Table 4. FIGS. 12A-12C show the transformed coefficients for each position based on the 5×5 diamond.

TABLE 4
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter f(k,l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R(i,j) within the block is filtered, resulting in sample value R′(i,j) as shown below, where L denotes filter length, f_{m,n} represents filter coefficient, and f(k,l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

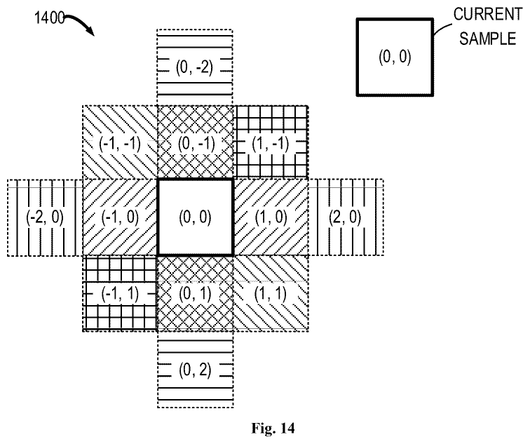

FIG. 14 illustrates an example diagram 1400 showing examples of relative coordinates for the 5×5 diamond filter support. FIG. 14 shows an example of relative coordinates used for 5×5 diamond filter support supposing the current sample's coordinate (i,j) to be (0, 0). Samples in different coordinates filled with the same color are multiplied with the same filter coefficients.

### 2.7. Geometry Transformation-based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) \cdot I ( x + i , y + j ) , \qquad ( 11 )$$

where samples I(x+i, y+j) are input samples, O(x,y) is the filtered output sample (i.e. filter result), and w(i,j) denotes the filter coefficients. In practice, in VTM4.0 it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64 ) >> 7 , \qquad ( 12 )$$

where L denotes the filter length, and where w(i,j) are the filter coefficients in fixed point precision.

The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (11) can be reformulated without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) ) , \qquad ( 13 )$$

where w(i,j) are the same filter coefficients as in equation (11) [excepted w(0, 0) which is equal to 1 in equation (13) while it is equal to 1−Σ_{(i,j)≠(0,0)}w(i,j) in equation (11)].

Using this above filter formula of (13), VVC introduces the non-linearity to make ALF more efficient by using a simple clipping function to reduce the impact of neighbor sample values (I(x+i,y+j)) when they are too different with the current sample value (I(x,y)) being filtered.

More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) ) , \qquad ( 14 )$$

where K(d,b)=min(b, max(−b,d)) is the clipping function, and k(i,j) are clipping parameters, which depends on the (i,j) filter coefficient. The encoder performs the optimization to find the best k(i,j). In some implementation, the clipping parameters k(i,j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The sets of clipping values are provided in the Table 5. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 … N ] \} , with M = {2}^{10} and N = 4. \qquad ( 15 )$$

Similarly, the Chroma tables of clipping values is obtained according to the following formula:

$${AlfClip}_{L} = \{ round ( A \cdot {( {( \frac{M}{A} )}^{\frac{1}{N - 1}} )}^{N - n} ) for n ∈ 1 … N ] \} , with M = {2}^{10} , N = 4 and A = 4. \qquad ( 16 )$$

TABLE 5
Authorized clipping values

| | INTRA/INTER tile group |
|---|---|
| LUMA | {1024, 181, 32, 6} |
| CHROMA | {1024, 161, 25, 4} |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Bilateral In-Loop Filter

### 2.9.1. Bilateral Image Filter

Bilateral image filter is a nonlinear filter that smooths the noise while preserving edge structures. The bilateral filtering is a technique to make the filter weights decrease not only with the distance between the samples but also with increasing difference in intensity. This way, over-smoothing of edges can be ameliorated. A weight is defined as

$$w ( Δ x , Δ γ , Δ I ) = {e}^{- \frac{Δ {x}^{2} + Δ {γ}^{2}}{2 {σ}_{d}^{2}} - \frac{Δ {I}^{2}}{2 {σ}_{r}^{2}}}$$

where Δx and Δy is the distance in the vertical and horizontal and ΔI is the difference in intensity between the samples.

The edge-preserving de-noising bilateral filter adopts a low-pass Gaussian filter for both the domain filter and the range filter. The domain low-pass Gaussian filter gives higher weight to pixels that are spatially close to the center pixel. The range low-pass Gaussian filter gives higher weight to pixels that are similar to the center pixel. Combining the range filter and the domain filter, a bilateral filter at an edge pixel becomes an elongated Gaussian filter that is oriented along the edge and is greatly reduced in gradient direction. This is the reason why the bilateral filter can smooth the noise while preserving edge structures.

### 2.9.2. Bilateral Filter in Video Coding

The bilateral filter in video coding is proposed as a coding tool for the VVC. The filter acts as a loop filter in parallel with the sample adaptive offset (SAO) filter. Both the bilateral filter and SAO act on the same input samples, each filter produces an offset, and these offsets are then added to the input sample to produce an output sample that, after clipping, goes to the next stage. The spatial filtering strength σ_{d} is determined by the block size, with smaller blocks filtered more strongly, and the intensity filtering strength σᵣ is determined by the quantization parameter, with stronger filtering being used for higher QPs. Only the four closest samples are used, so the filtered sample intensity I_{F} can be calculated as

$${I}_{F} = {I}_{C} + \frac{{w}_{A} Δ {I}_{A} + {w}_{B} Δ {I}_{B} + {w}_{L} Δ {I}_{L} + {w}_{R} Δ {I}_{R}}{{w}_{C} + {w}_{A} + {w}_{B} + {w}_{L} + {w}_{R}}$$

where I_{C} denotes the intensity of the center sample, ΔI_{A}=I_{A}−I_{C} the intensity difference between the center sample and the sample above. ΔI_{B}, ΔI_{L} and ΔI_{R} denote the intensity difference between the center sample and that of the sample below, to the left and to the right respectively.

### 2.10. Convolutional Neural Network-Based Loop Filters for Video Coding

### 2.10.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.

CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 2.10.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks. While purely relying on neural networks for image/video compression can avoid any manual optimizations or hand-crafted designs, compression efficiency may be not satisfactory. Therefore, works distributed in the second type take neural networks as an auxiliary, and enhance traditional compression frameworks by replacing or enhancing some modules. In this way, they can inherit the merits of the highly optimized traditional frameworks. For example, a fully connected network for the intra prediction is proposed. In addition to intra prediction, deep learning is also exploited to enhance other modules. For example, the in-loop filters of HEVC with a convolutional neural network is replaced and promising results are achieved. Neural networks are applied to improve the arithmetic coding engine.

### 2.10.3. Convolutional Neural Network Based In-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.10.3.1. Training

The purpose of the training processing is to find the optimal value of parameters including weights and bias. First, a codec (e.g. HM, JEM, VTM, etc.) is used to compress the training dataset to generate the distorted reconstruction frames.

Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 2.10.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

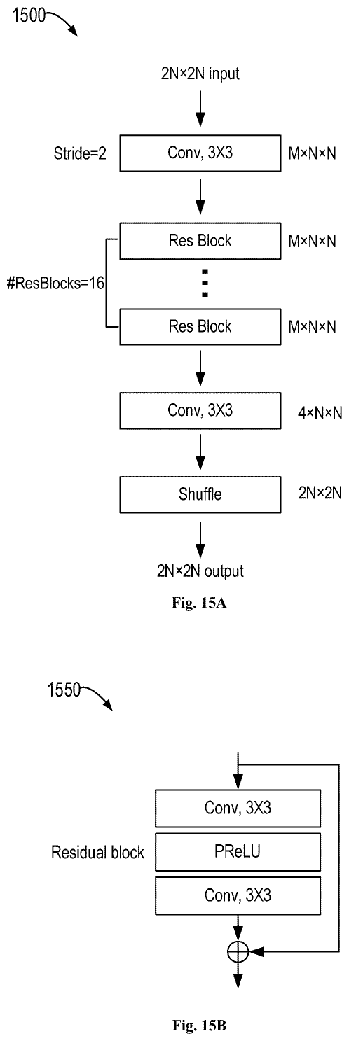

FIG. 15A illustrates an example diagram 1500 showing Architecture of the proposed CNN filter. FIG. 15B illustrates an example diagram 1550 showing a construction of ResBlock (residual block) in the CNN filter. In most of deep convolutional neural networks, residual blocks are utilized as the basic module and stacked several times to construct the final network where in one example, the residual block is obtained by combining a convolutional layer, a ReLU/PReLU activation function and a convolutional layer as shown in FIG. 15B.

### 2.10.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. Problems

In the prior art design of neural network-based filters (NN filters), feature extraction, backbone and tail are considered as the main structure of enhancement and/or super resolution of the reconstruction wherein the signals in compression domain such as reconstruction, prediction, partitioning, boundary strength (BS) and quantization step (QP) are utilized as input of network. Multiple NN filters could solve the problem that single network structure may not adapt to the various content. However, storage overhead multiplies when considering multiple networks. Separable network could solve this problem by exchanging the input of network, exchanging the output of network, replacing important sub-modules or selecting the sub-modules in multiple pretrained sub-models in the whole network.

### 4. Detailed Solutions

The detailed solutions below should be considered as examples to explain general concepts. These solutions should not be interpreted in a narrow way. Furthermore, these solutions can be combined in any manner. To solve the above problem, it is proposed to design separable NN filter. The present disclosure proposes how to design the separable NN filter, how to utilize or control separable filtered samples to generate the reconstruction.

In the disclosure, a neural network (NN) filter can be any kind of filter, such as a convolutional neural network (CNN) filter. In the following discussion, a NN filter may also be referred to as a CNN filter. In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.

The width and height of a video unit are denoted as W and H, respectively.
1. It is proposed that at least one NN filter may be included in a decoder or encoder compatible to a video coding standard, such as H.264/AVC, H.265/HEVC, H.266/VVC, AVS1/2/3, AV1/AV2, etc.
   a. In one example, NN filters may be used to enhance the reconstruction of decoded pictures.
      i. In one example, the reconstruction is generated by prediction and residual.
      ii. In one example, the reconstruction is the filtered output signal of other filters.
   b. In one example, NN filters may be used to do up sampling on the luma and/or chroma reconstruction.
   c. In one example, NN filters may be used to super resolution.
   d. In one example, additional information may be involved in the input part of NN filter.
      i. In one example, additional information may include prediction and/or partition and/or boundary strength and/or QP map.
      ii. In one example, additional information may include coding mode.
      iii. In one example, additional information may be generated by reconstruction and/or decoded information and/or signals indicated in a bitstream.
      iv. In one example, the additional information may be associated with current blocks and/or neighboring blocks and/or those in a different picture.
      v. In one example, signals from luma component may be involved in the additional information for chroma component.
2. It is proposed that a sub-module/sub-structure of NN filter may be separable or selectable.
   a. In one example, a sub-modules/sub-structure may be the head module and/or the backbone module and/or the tail module and/or the output layer and/or the feature extraction.
   b. In one example, the whole network could work normally when the sub-modules/sub-structure is replaced by a different sub-module/sub-structure.
   c. In one example, the sub-module could be selected/exchanged when there are multiple sub-models with the same features or purposes.
      i. In one example, the sub-modules with same purposes designed for different color components could be selected/exchanged when sub-modules are different for color components.
         1) In one example, the sub-module for input signals of Y and/or Cb (U) and/or Cr(V) and/or R and/or G and/or B components may be selected/exchanged.
      ii. In one example, sub-modules could be selected/exchanged when there may be multiple sub-modules designed for one component.
      iii. the sub-modules with same functions designed for different color components could be selected/exchanged when sub-modules are different for color components.
      iv. In one example, the sub-modules may be feature extraction.
   d. In one example, the output of the sub-modules may be selected.
      i. In one example, the selection may be happened when the sub-module is the current sub-modules or the next sub-modules after current sub-modules, and the current sub-modules are exchanged or replaced by another sub-module.
3. It is proposed that the output of sub-modules/sub-structures of NN filter may be selectable.
   a. In one example, the sub-modules/sub-structures may be head module and/or backbone module and/or tail module and/or output layer and/or feature extraction.
   b. In one example, the whole network could work normally when the output of sub-module/sub-structure is exchanged.
   c. In one example, the output of the next sub-modules may be exchanged according to the result of whether to exchange the output of current sub-modules.
      i. In one example, the exchange may be happened when the input of the next sub-module is the output of the current sub-modules, and the output of current sub-modules are exchanged.
      ii. In one example, the exchange may be happened when the input of the next sub-module is the output of the other sub-modules after current sub-modules, and the output of current sub-modules are exchanged.
      iii. In one example, the exchange may be happened when the next sub-modules are the final sub-modules, and the output of current sub-modules are exchanged.
      iv. In one example, the exchange may be dependent on the the coding modes/statistics of the video unit (e.g., prediction modes, qp, temporal layer, slice type, etc.).
         1) In one example, it may be dependent on the prediction modes, qp, temporal layer, slice type, etc.
         2) In one example, it may be dependent on the quantization step.
         3) In one example, it may be dependent on the temporal layer.
         4) In one example, it may be dependent on the slice type.
         5) In one example, it may be dependent on the block size of the video unit.
         6) In one example, it may be dependent on the color components.
         7) In one example, it may be dependent on the signals in the bitstream.
         a. In one example, the signals may be in a sequence and/or a picture and/or a slice and/or a tile and/or a brick and/or a subpicture and/or a CTU/CTB and/or a CTU/CTB row and/or one CU/CB and/or multiple CUs/CBs.
         8) In one example, it may be dependent on the cost of rate distortion optimization in the encoder.
4. It is proposed that the input of sub-modules/sub-structures of NN filter may be selectable.
   a. In one example, the sub-modules/sub-structures may be head module and/or backbone module and/or tail module and/or output layer and/or feature extraction.
   b. In one example, the whole network could work normally when the inputs of sub-modules/sub-structures are exchanged.
   c. In one example, the output of the sub-modules may be exchanged according to the result of whether to exchange the input of current sub-modules.
      i. In one example, the exchange may be happened when the sub-modules are the current sub-modules, and the inputs of current sub-modules are exchanged.
      ii. In one example, the exchange may be happened when the input of the sub-module is the output of the current sub-modules, and the inputs of current sub-modules are exchanged.
      iii. In one example, the exchange may be happened when the input of the sub-module is the output of the other sub-modules after current sub-modules, and the inputs of current sub-modules are exchanged.
      iv. In one example, the exchange may be happened when the sub-modules are the final sub-modules, and the input of current sub-modules are exchanged.
      v. In one example, the exchange may be dependent on the the coding modes/statistics of the video unit (e.g., prediction modes, qp, temporal layer, slice type, etc.).
         1) In one example, it may be dependent on the prediction modes, qp, temporal layer, slice type, etc.
         2) In one example, it may be dependent on the quantization step.
         3) In one example, it may be dependent on the temporal layer.
         4) In one example, it may be dependent on the slice type.
         5) In one example, it may be dependent on the block size of the video unit.
         6) In one example, it may be dependent on the color components.
         7) In one example, it may be dependent on the signals in the bitstream.
         a. In one example, the signals may be in a sequence and/or a picture and/or a slice and/or a tile and/or a brick and/or a subpicture and/or a CTU/CTB and/or a CTU/CTB row and/or one CU/CB and/or multiple CUs/CBs.
         8) In one example, it may be dependent on the cost of rate distortion optimization in the encoder.
   d. In one example, the outputs of NN filter may be selected or exchanged when input of NN filter is exchanged. The input signal of NN filter could be defined as I₀, I₁, I₂ and the output signal of NN filter could be defined as R₀, R₁, R₂. When the inputs are exchanged, the input signal of NN filter could be defined as I₀, I₂, I₁ and the output signal of NN filter could be defined as R′₀, R′₂, R′₁.
      i. In one example, the output signal of NN filter may be exchanged to R′₀, R′₁, R′₂.
      ii. In one example, the output signal R₀ and R′₀ of NN filter with different inputs may be selected.
         1) In one example, whether to/how to select the output signal may be dependent on the coding modes/statistics of the video unit.
      iii. In one example, input signal I₀, I₁, I₂ may be referred to a set of reconstruction and/or prediction and/or boundary strength and/or partition of C₀, C₁, C₂ components and the output signal of NN filter may be referred to the enhanced reconstruction of C₀, C₁, C₂ components.
         1) In one example, C₀, C₁, C₂ may be one component of Y, U(Cb), V(Cr) components.
         2) In one example, C₀, C₁, C₂ may be one component of R, G, B components.
5. Whether to and/or how to select/exchange the sub-module and/or the input of sub-module and/or the output of sub-module may be dependent on certain or adaptive method.
   a. In one example, the sub-module for input signals of different component such as Y and/or Cb (U) and/or Cr(V) could be selected/exchanged in the encoder or decoder.
   b. In one example, the input signals of different component such as Y and/or Cb (U) and/or Cr(V) could be selected/exchanged before being fed into sub-modules in the encoder or decoder.
   c. In one example, the output signals of NN filters for different component such as Y and/or Cb (U) and/or Cr(V) could be selected/exchanged in the encoder or decoder.
6. Whether to and/or how to select/exchange the sub-module and/or the input of sub-module and/or the output of sub-module may be dependent on the coding modes/statistics of the video unit (e.g., prediction modes, qp, temporal layer, slice type, etc.).
   a. In one example, it may be dependent on the prediction modes, qp, temporal layer, slice type, etc.
   b. In one example, it may be dependent on the quantization step.
   c. In one example, it may be dependent on the temporal layer.
   d. In one example, it may be dependent on the slice type.
   e. In one example, it may be dependent on the block size of the video unit.
   f. In one example, it may be dependent on the color components.
   g. In one example, it may be dependent on the signals in the bitstream.
      i. In one example, the signals may be in a sequence and/or a picture and/or a slice and/or a tile and/or a brick and/or a subpicture and/or a CTU/CTB and/or a CTU/CTB row and/or one CU/CB and/or multiple CUs/CBs.
   h. In one example, it may be dependent on the cost of rate distortion optimization in the encoder.
7. It is proposed that the output of NN filters may be selected when the sub-module and/or the input of sub-module and/or the output of sub-module are exchanged or selected.
   a. Whether to and/or how to select/use output of NN filters may be dependent on certain or adaptive method.
   b. Whether to and/or how to select/use output of NN filters may be dependent on the coding modes/statistics of the video unit (e.g., prediction modes, qp, temporal layer, slice type, etc.).
      i. In one example, it may be dependent on the prediction modes, qp, temporal layer, slice type, etc.
      ii. In one example, it may be dependent on the quantization step.
      iii. In one example, it may be dependent on the temporal layer.
      iv. In one example, it may be dependent on the slice type.
      v. In one example, it may be dependent on the block size of the video unit.
      vi. In one example, it may be dependent on the color components.
      vii. In one example, it may be dependent on the signals in the bitstream.
         1) In one example, the signals may be in a sequence and/or a picture and/or a slice and/or a tile and/or a brick and/or a subpicture and/or a CTU/CTB and/or a CTU/CTB row and/or one CU/CB and/or multiple CUs/CBs.
      viii. In one example, it may be dependent on the cost of rate distortion optimization in the encoder.
8. Whether to and/or how to do select the sub-model/sub-structure may be signaled from an encoder to a decoder.
   a. In one example, the number of sub-models/sub-structures to be selected may be predefined or signaled with at least one syntax element (SE).
   b. In one example, the index of the selected sub-model/sub-structure may be selected with at least one SE.
9. General aspects
10. A syntax element disclosed above may be binarized as a flag, a fixed length code, an EG(x) code, a unary code, a truncated unary code, a truncated binary code, etc. It can be signed or unsigned.
11. A syntax element disclosed above may be coded with at least one context model. Or it may be bypass coded.
12. A syntax element disclosed above may be signaled in a conditional way.
   a. The SE is signaled only if the corresponding function is applicable.
   b. The SE is signaled only if the dimensions (width and/or height) of the block satisfy a condition.
13. A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
14. The proposed method(s) may be combined with another coding tool such as affine/MTS/LFNST/MMVD/MIP/ISP/CCLM/CCCM/SMVD/BDOF/DMVR/HMVP/Template Matching/IBC/Palette/etc.
15. The proposed method(s) may be excluded with another coding tool such as affine/MTS/LFNST/MMVD/MIP/ISP/CCLM/CCCM/SMVD/BDOF/DMVR/HMVP/Template Matching/IBC/Palette/etc.
   a. In one example, if the proposed method(s) is used, the excluded coding tool is disabled implicitly without signaling.
   b. In one example, if the excluded coding tool is used, the proposed method(s) is disabled implicitly without signaling.

### 5. Embodiment

### 5.1 Embodiment #1

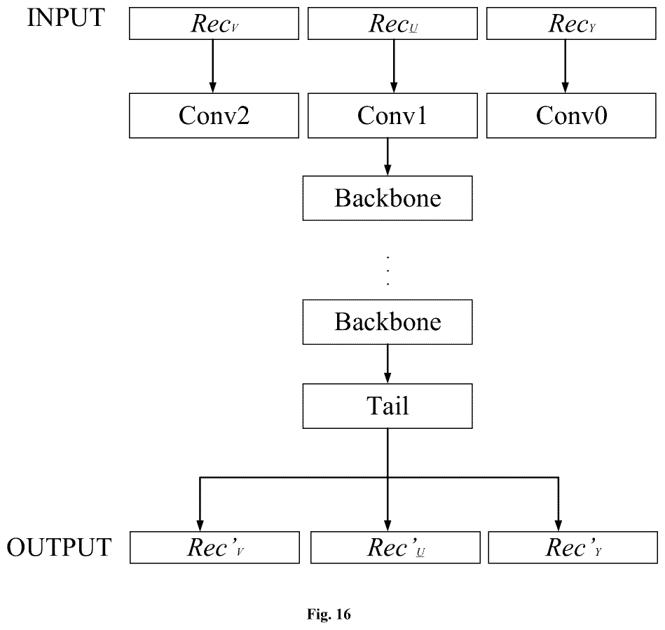

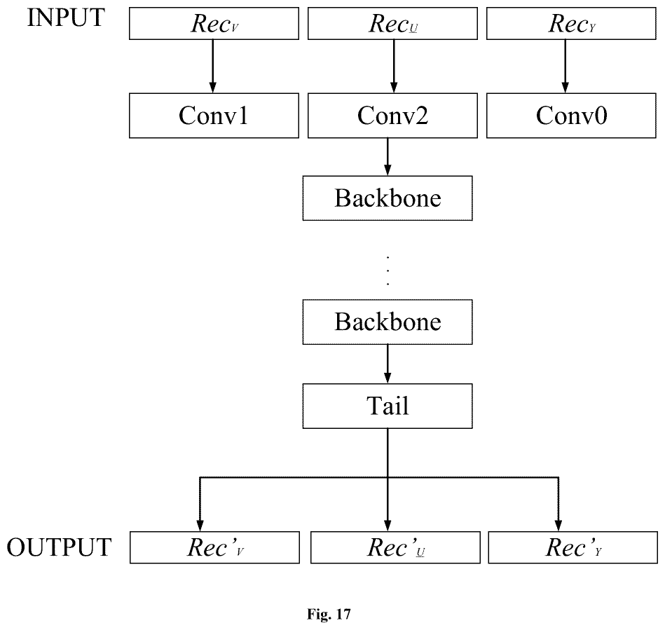

This embodiment is for invention item 2, item 7 and all its subitems summarized above in Section 4. FIG. 16 shows a basic network structure of neural network based in-loop filter. FIG. 17 shows a modified network structure of neural network based in-loop filter.

The neural network-based filter is utilized to enhance the reconstruction for Y, U and V components. The reconstruction of Y, U and V components are used as the input of network. The basic network structure is illustrated as FIG. 16. Herein, we exchange the feature extraction layer of Conv1 and Conv2 for U and V components to design a new modified network which is illustrated as FIG. 17. The output reconstruction of Y, U and V components could be selected from the output of the basic network and the modified network.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. As used herein, the term “an independent filter (ID) filter” may refer to a filter is not exactly same with other filters and some parts of the filters are different, such as the input of the filter, the structure of the filter, the parameters of filter, the neural network model of the filter. In one example, the design of ID-Filter is unique and different with the design of other filters. In one example, the inputs of ID-Filter are different when filters share the consistent structure or consistent parameters or consistent model of neural network. ID-Filter can be any kind of filters, including filters without neural network (non-NN filter) and filters with neural network (NN filter). A Non-NN Filter may be one of deblocking filter (DF), sample adaptive offset (SAO), adaptive loop filter (ALF), etc. A NN filter can be any kind of NN filter, such as a convolutional neural network (CNN) filter. In the following discussion, a NN filter may also be referred to as a CNN filter.

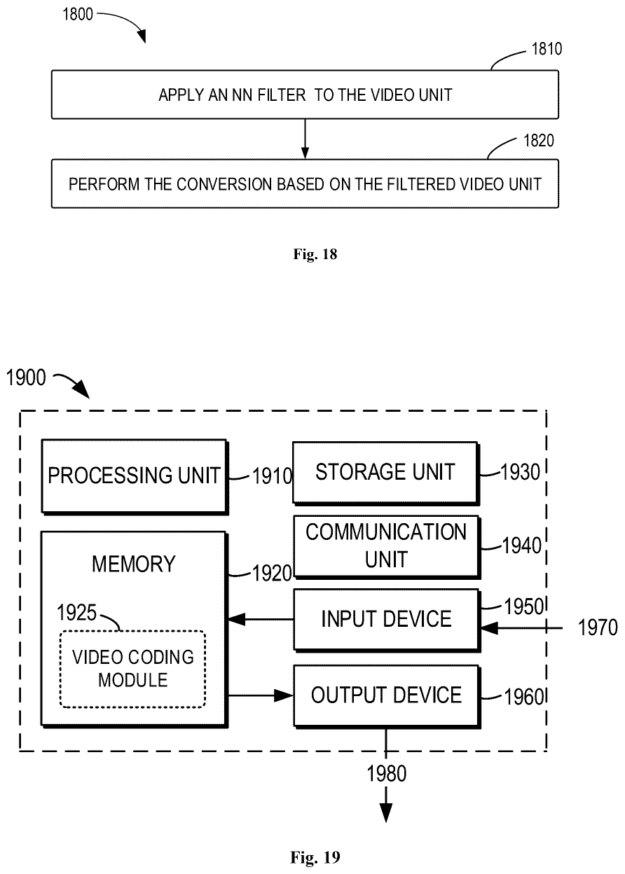

FIG. 18 illustrates a flowchart of a method 1800 for video processing in accordance with embodiments of the present disclosure. The method 1800 is implemented during a conversion between a video unit of a video and a bitstream of the video.

At block 1810, a neural network (NN) filter is applied to the video unit. The NN filter comprises a set of sub-modules, at least one of: the set of sub-modules, inputs of the set of sub-modules, or outputs of the set of sub-modules is selectable. In some embodiments, the NN filter is included in a decoder or encoder.

At block 1820, the conversion is performed based on the NN filter. In some embodiments, the conversion may include encoding the video unit into the bitstream. Alternatively, or in addition, the conversion may include decoding the video unit from the bitstream. Compared with the conventional solution, it can solve the storage overheads. In this way, the coding effectiveness and coding efficiency can be improved.

In some embodiments, the NN filter is used to enhance a reconstruction of decoded pictures. For example, the reconstruction is generated by prediction and residual. As another example, the reconstruction is a filtered output signal of other filters.

In some embodiments, the NN filter is used to do up sampling on at least one of a luma reconstruction or chroma reconstruction. In some other embodiments, the NN filter is used to super resolution.

In some embodiments, additional information is involved in an input part of the NN filter. For example, the additional information comprises at least one of: a prediction, a partition, a boundary strength, or a quantization parameter (QP) map. In some other embodiments, the additional information comprises a coding mode. In some embodiments, the additional information is generated by at least one of: a reconstruction, decoded information, or a signal indicated in a bitstream. In some embodiments, the additional information is associated with at least one of: a current block, a neighboring block, or a neighboring block in a different picture.

In some embodiments, signals from luma component are involved in the additional information for chroma component. For example, a sub-module in the NN filter comprises at least one of: a head module, a backbone module, a tail module, an output layer, or a feature extraction.

In some embodiments, if the sub-module is replaced by a different sub-module, the NN filter works in a same way. Alternatively, or in addition, if an output of the sub-module is exchanged, the NN filter works in a same way. Alternatively, or in addition, if an input of the sub-module is exchanged, the NN filter works in a same way.

In some embodiments, if a plurality of sub-modules is with same features or purposes, the sub-module is selected or exchanged. In some other embodiments, if the plurality of sub-modules is different for color components, the sub-module with same purposes designed for different color components is selected or exchanged. For example, if the sub-module is for an input signals of at least one of: Y component, Cb(U) component, Cr(V) component, R component, G component, or B component, the sub-module is selected.

In some embodiments, if a plurality of sub-modules is designed for one component, the sub-module is selected or exchanged. In some other embodiments, if the plurality of sub-modules is different for color components, the sub-module with same functions designed for different color components is selected or exchanged. In some embodiments, the sub-module is a feature extraction.

In one example, the output of the sub-modules may be selected. In some embodiments, if a sub-module is a current sub-module or a subsequent sub-module after current sub-module, and the current sub-module is exchanged or replaced by another sub-module, an output of the sub-module is selected.

In some embodiments, an output of a subsequent sub-module is exchanged according to a result of whether to exchange an output of a current sub-module. In some embodiments, if an input of the subsequent sub-module is the output of the current sub-module and the output of the current sub-module is exchanged, the output of the subsequent sub-module is exchanged. In some other embodiments, if an input of the subsequent sub-module is an output of other sub-modules after the current sub-module, and the output of the current sub-module is exchanged, the output of the subsequent sub-module is exchanged. Alternately, if the subsequent sub-module is a final sub-module, and the output of the current sub-module is exchanged, the output of the subsequent sub-module is exchanged.

In some embodiments, the exchange of the output of the subsequent sub-module is dependent on coding mode or coding statistics of the video unit. In this case, the coding statistics may include at least one of: a prediction mode, QP, temporal layer, or slice type.

In some embodiments, the exchange of the output of the subsequent sub-module is dependent on at least one of: a prediction mode, QP, temporal layer, or slice type. In some other embodiments, the exchange of the output of the subsequent sub-module is dependent on a quantization step. Alternatively, the exchange of the output of the subsequent sub-module is dependent on a temporal layer. In some further embodiments, the exchange of the output of the subsequent sub-module is dependent on a slice type.

In some embodiments, the exchange of the output of the subsequent sub-module is dependent on a block size of the video unit. In some other embodiments, the exchange of the output of the subsequent sub-module is dependent on color components.

In some embodiments, the exchange of the output of the subsequent sub-module is dependent on signals in the bitstream. For example, the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs. In some embodiments, the exchange of the output of the subsequent sub-module is dependent on a cost of a rate distortion optimization in an encoder.

In some embodiments, an output of a subsequent sub-module is exchanged according to a result of whether to exchange an input of a current sub-module. For example, if the sub-module is a current sub-module and an input of the current sub-module is exchanged, the output of the subsequent sub-module is exchanged. As another example, if an input of the subsequent sub-module is the output of the current sub-module and the input of the current sub-module is exchanged, the output of the subsequent sub-module is exchanged. As a further example, if an input of the subsequent sub-module is an output of other sub-modules after the current sub-module, and the input of the current sub-module is exchanged, the output of the subsequent sub-module is exchanged. By way of example, if the subsequent sub-module is a final sub-module, and the input of the current sub-module is exchanged, the output of the subsequent sub-module is exchanged.

In some embodiments, the exchange of the output of the subsequent sub-module is dependent on coding mode or coding statistics of the video unit. For example, the coding statistics comprise at least one of: a prediction mode, QP, temporal layer, or slice type.

In some embodiments, the exchange of the output of the subsequent sub-module is dependent on at least one of: a prediction mode, QP, temporal layer, or slice type. In some other embodiments, the exchange of the output of the subsequent sub-module is dependent on a quantization step. In some further embodiments, the exchange of the output of the subsequent sub-module is dependent on a temporal layer. Alternatively, the exchange of the output of the subsequent sub-module is dependent on a slice type.

In some embodiments, the exchange of the output of the subsequent sub-module is dependent on a block size of the video unit. In some other embodiments, the exchange of the output of the subsequent sub-module is dependent on color components.

In some embodiments, the exchange of the output of the subsequent sub-module is dependent on signals in the bitstream. For example, the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs. In some embodiments, the exchange of the output of the subsequent sub-module is dependent on a cost of a rate distortion optimization in an encoder.

In some embodiments, if an input of the NN filter is exchanged, an output of the NN filter is selected or exchanged.

In some embodiments, input signals of the NN filter comprise I₀, I₁, I₂ and corresponding output signals of the NN filter comprise R₀, R₁, R₂, and wherein if the input signals are exchanged, the output signals of the NN filter are changed to R′₀, R′₂, R′₁.

In some embodiments, an output signal and a changed output signal of the NN filter with different inputs are selected. In one example, the output signal R₀ and R′₀ of NN filter with different inputs may be selected. In some embodiments, whether to/how to select the output signal is dependent on coding modes or coding statistics of the video unit.

In some embodiments, input signals of the NN filter comprise at least one of: a set of reconstructions, a set of predictions, a set of boundary strengths, or a partition of components, and output signals of the NN filter comprise enhanced reconstruction of the components. In one example, input signal I₀, I₁, I₂ may be referred to a set of reconstruction and/or prediction and/or boundary strength and/or partition of C₀, C₁, C₂ components and the output signal of NN filter may be referred to the enhanced reconstruction of C₀, C₁, C₂ components.

In some embodiments, the components (i.e., C₀, C₁, C₂) comprise one component of Y, Cb, or Cr components. In some other embodiments, the components (i.e., C₀, C₁, C₂) comprise one component of R, G, or B components.

In some embodiments, whether to and/or how to select at least one of: the set of sub-modules, inputs of the set of sub-modules, or outputs of the set of sub-modules is dependent on a predefined or adaptive method.

In some embodiments, a sub-module for input signals of different components (such as Y and/or Cb (U) and/or Cr(V)) is selected in an encoder or decoder. In some embodiments, input signals of different components (such as Y and/or Cb (U) and/or Cr(V)) are selected before being fed into the set of sub-modules in an encoder or decoder. In some embodiments, output signals of the NN filter for different components (such as Y and/or Cb (U) and/or Cr(V)) are selected in an encoder or decoder.

In some embodiments, whether to and/or how to select at least one of: the set of sub-modules, inputs of the set of sub-modules, or outputs of the set of sub-modules is dependent on coding modes or coding statistics of the video unit. For example, the coding statistics comprise at least one of: a prediction mode, QP, temporal layer, or slice type.

In some embodiments, whether to and/or how to select at least one of: the set of sub-modules, inputs of the set of sub-modules, or outputs of the set of sub-modules is dependent on at least one of: a prediction mode, QP, temporal layer, or slice type. In some other embodiments, whether to and/or how to select at least one of: the set of sub-modules, inputs of the set of sub-modules, or outputs of the set of sub-modules is dependent on a quantization step. In some further embodiments, whether to and/or how to select at least one of: the set of sub-modules, inputs of the set of sub-modules, or outputs of the set of sub-modules is dependent on a temporal layer.

In some embodiments, whether to and/or how to select at least one of: the set of sub-modules, inputs of the set of sub-modules, or outputs of the set of sub-modules is dependent on a slice type. In some other embodiments, whether to and/or how to select at least one of: the set of sub-modules, inputs of the set of sub-modules, or outputs of the set of sub-modules is dependent on a block size of the video unit. In some further embodiments, whether to and/or how to select at least one of: the set of sub-modules, inputs of the set of sub-modules, or outputs of the set of sub-modules is dependent on color components.

In some embodiments, whether to and/or how to select at least one of: the set of sub-modules, inputs of the set of sub-modules, or outputs of the set of sub-modules is dependent on is dependent on signals in the bitstream. For example, the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs. In some embodiments, whether to and/or how to select at least one of: the set of sub-modules, inputs of the set of sub-modules, or outputs of the set of sub-modules is dependent on a cost of a rate distortion optimization in an encoder.

In some embodiments, if at least one of: the set of sub-modules, inputs of the set of sub-modules, or outputs of the set of sub-modules is selected, an output of the NN filter is selected. In some embodiments, whether to and/or how to select the output of the NN filter is dependent on a predefined method or adaptive method.

In some embodiments, whether to and/or how to select the output of the NN filter is dependent on coding modes or coding statistics of the video unit. For example, the coding statistics comprise at least one of: a prediction mode, QP, temporal layer, or slice type.

In some embodiments, whether to and/or how to select the output of the NN filter is dependent on at least one of: a prediction mode, QP, temporal layer, or slice type. In some other embodiments, whether to and/or how to select the output of the NN filter is dependent on a quantization step. In some further embodiments, whether to and/or how to select the output of the NN filter is dependent on a temporal layer.

In some embodiments, whether to and/or how to select the output of the NN filter is dependent on a slice type. In some other embodiments, whether to and/or how to select the output of the NN filter is dependent on a block size of the video unit. In some further embodiments, whether to and/or how to select the output of the NN filter is dependent on color components.

In some embodiments, whether to and/or how to select the output of the NN filter is dependent on is dependent on signals in the bitstream. For example, the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs. In some embodiments, whether to and/or how to select the output of the NN filter is dependent on a cost of a rate distortion optimization in an encoder.

In some embodiments, whether to and/or how to select at least one of: the set of sub-modules, inputs of the set of sub-modules, or outputs of the set of sub-modules is indicated from an encoder to a decoder. For example, the number of sub-module to be selected is predefined. As another example, the number of sub-models to be selected is signaled with at least one syntax element (SE). In some embodiments, an index of a selected sub-module is selected with at least one SE.

In some embodiments, the SE is binarized as one of a flag, a fixed length code, an EG(x) code, a unary code, a truncated unary code, or a truncated binary code. In some embodiments, the SE is signed or unsigned. In some embodiments, the SE is coded with at least one context model. Alternatively, the SE is bypass coded.

In some embodiments, the SE is signaled in a conditional way. For example, the SE is signaled only if a corresponding function is applicable. As another example, the SE is signaled only if dimensions of the video unit satisfy a condition.

In some embodiments, the SE is indicated at one of the followings: sequence level, group of pictures level, picture level, slice level, or tile group level. In some embodiments, the SE is indicated at one of the followings: a prediction block (PB), a transform block (TB), a coding block (CB), a prediction unit (PU), a transform unit (TU), a coding unit (CU), a coding tree block (CTB), or a coding tree unit (CTU).

In some embodiments, the video unit is coded with a coding tool. Alternatively, the video unit is excluded to be coded with the coding tool. In some embodiments, the coding tool comprises one of: affine, multiple transform selection (MTS), low-frequency non-separable transform (LFNST), a merge mode with motion vector difference (MMVD), matrix weighted intra prediction (MIP), intra sub-partitions (ISP), Cross-Component Linear Model (CCLM), convolutional cross-component model (CCCM), Symmetric motion vector difference (SMVD) signalling, Bi-directional optical flow (BDOF), Decoder side motion vector refinement (DMVR), history-based motion vector prediction (HMVP), Template Matching, intra block copy (IBC), or palette. For example, embodiments of the present disclosure may be combined with another coding tool such as affine/MTS/LFNST/MMVD/MIP/ISP/CCLM/CCCM/SMVD/BDOF/DMVR/HMVP/Template Matching/IBC/Palette/etc. Alternatively, embodiments of the present disclosure may be excluded with another coding tool such as affine/MTS/LFNST/MMVD/MIP/ISP/CCLM/CCCM/SMVD/BDOF/DMVR/HMVP/Template Matching/IBC/Palette/etc.

In some embodiments, if the NN filter including a selectable sub-module or selectable input or output of the sub-module is applied, the coding tool is disabled implicitly without signaling. In one example, if the proposed method(s) is used, the excluded coding tool is disabled implicitly without signaling. Alternatively, if the coding tool is used, the NN filter including a selectable sub-module or selectable input or output of the sub-module is disabled implicitly without signaling. In one example, if the excluded coding tool is used, the proposed method(s) is disabled implicitly without signaling.

According to further embodiments of the present disclosure, a non-transitory computer-readable recording medium is provided. The non-transitory computer-readable recording medium stores a bitstream of a video which is generated by a method performed by an apparatus for video processing. The method comprises: applying a neural network (NN) filter to a video unit of the video, wherein the NN filter comprises a set of sub-modules, at least one of: the set of sub-modules, inputs of the set of sub-modules, or outputs of the set of sub-modules is selectable; and generating a bitstream of the video based on the NN filter.

According to still further embodiments of the present disclosure, a method for storing bitstream of a video is provided. The method comprises: applying a neural network (NN) filter to a video unit of the video, wherein the NN filter comprises a set of sub-modules, at least one of: the set of sub-modules, inputs of the set of sub-modules, or outputs of the set of sub-modules is selectable; generating a bitstream of the video based on the NN filter; and storing the bitstream in a non-transitory computer-readable recording medium.

Implementations of the present disclosure can be described in view of the following clauses, the features of which can be combined in any reasonable manner.

Clause 1. A method of video processing, comprising: applying, for a conversion between a video unit of a video and a bitstream of the video, a neural network (NN) filter to the video unit, wherein the NN filter comprises a set of sub-modules, at least one of: the set of sub-modules, inputs of the set of sub-modules, or outputs of the set of sub-modules is selectable; and performing the conversion based on the NN filter.

Clause 2. The method of clause 1, wherein the NN filter is included in a decoder or encoder.

Clause 3. The method of clause 1, wherein the NN filter is used to enhance a reconstruction of decoded pictures.

Clause 4. The method of clause 3, wherein the reconstruction is generated by prediction and residual, or wherein the reconstruction is a filtered output signal of other filters.

Clause 5. The method of clause 1, wherein the NN filter is used to do up sampling on at least one of a luma reconstruction or chroma reconstruction, or wherein the NN filter is used to super resolution.

Clause 6. The method of clause 1, wherein additional information is involved in an input part of the NN filter.

Clause 7. The method of clause 6, wherein the additional information comprises at least one of: a prediction, a partition, a boundary strength, or a quantization parameter (QP) map.

Clause 8. The method of clause 6, wherein the additional information comprises a coding mode.

Clause 9. The method of clause 6, wherein the additional information is generated by at least one of: a reconstruction, decoded information, or a signal indicated in a bitstream.

Clause 10. The method of clause 6, wherein the additional information is associated with at least one of: a current block, a neighboring block, or a neighboring block in a different picture.

Clause 11. The method of clause 6, wherein signals from luma component are involved in the additional information for chroma component.

Clause 12. The method of clause 1, wherein a sub-module in the NN filter comprises at least one of: a head module, a backbone module, a tail module, an output layer, or a feature extraction.

Clause 13. The method of clause 12, wherein if the sub-module is replaced by a different sub-module, the NN filter works in a same way, and/or wherein if an output of the sub-module is exchanged, the NN filter works in a same way, and/or wherein if an input of the sub-module is exchanged, the NN filter works in a same way.

Clause 14. The method of clause 12, wherein if a plurality of sub-modules is with same features or purposes, the sub-module is selected or exchanged.

Clause 15. The method of clause 14, wherein if the plurality of sub-modules is different for color components, the sub-module with same purposes designed for different color components is selected or exchanged.

Clause 16. The method of clause 15, wherein if the sub-module is for an input signals of at least one of: Y component, Cb component, Cr component, R component, G component, or B component, the sub-module is selected.

Clause 17. The method of clause 14, wherein if a plurality of sub-modules is designed for one component, the sub-module is selected or exchanged.

Clause 18. The method of clause 14, wherein if the plurality of sub-modules is different for color components, the sub-module with same functions designed for different color components is selected or exchanged.

Clause 19. The method of clause 14, wherein the sub-module is a feature extraction.

Clause 20. The method of clause 1, wherein if a sub-module is a current sub-module or a subsequent sub-module after current sub-module, and the current sub-module is exchanged or replaced by another sub-module, an output of the sub-module is selected.

Clause 21. The method of clause 1, wherein an output of a subsequent sub-module is exchanged according to a result of whether to exchange an output of a current sub-module.

Clause 22. The method of clause 21, wherein if an input of the subsequent sub-module is the output of the current sub-module and the output of the current sub-module is exchanged, the output of the subsequent sub-module is exchanged.

Clause 23. The method of clause 21, wherein if an input of the subsequent sub-module is an output of other sub-modules after the current sub-module, and the output of the current sub-module is exchanged, the output of the subsequent sub-module is exchanged.

Clause 24. The method of clause 21, wherein if the subsequent sub-module is a final sub-module, and the output of the current sub-module is exchanged, the output of the subsequent sub-module is exchanged.

Clause 25. The method of clause 21, wherein the exchange of the output of the subsequent sub-module is dependent on coding mode or coding statistics of the video unit.

Clause 26. The method of clause 25, wherein the coding statistics comprise at least one of: a prediction mode, QP, temporal layer, or slice type.

Clause 27. The method of clause 25, wherein the exchange of the output of the subsequent sub-module is dependent on at least one of: a prediction mode, QP, temporal layer, or slice type.

Clause 28. The method of clause 25, wherein the exchange of the output of the subsequent sub-module is dependent on a quantization step.

Clause 29. The method of clause 25, wherein the exchange of the output of the subsequent sub-module is dependent on a temporal layer.

Clause 30. The method of clause 25, wherein the exchange of the output of the subsequent sub-module is dependent on a slice type.

Clause 31. The method of clause 25, wherein the exchange of the output of the subsequent sub-module is dependent on a block size of the video unit.

Clause 32. The method of clause 25, wherein the exchange of the output of the subsequent sub-module is dependent on color components.

Clause 33. The method of clause 25, wherein the exchange of the output of the subsequent sub-module is dependent on signals in the bitstream.

Clause 34. The method of clause 33, wherein the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs.

Clause 35. The method of clause 25, wherein the exchange of the output of the subsequent sub-module is dependent on a cost of a rate distortion optimization in an encoder.

Clause 36. The method of clause 1, wherein an output of a subsequent sub-module is exchanged according to a result of whether to exchange an input of a current sub-module.

Clause 37. The method of clause 36, wherein if the sub-module is a current sub-module and an input of the current sub-module is exchanged, the output of the subsequent sub-module is exchanged.

Clause 38. The method of clause 36, wherein if an input of the subsequent sub-module is the output of the current sub-module and the input of the current sub-module is exchanged, the output of the subsequent sub-module is exchanged.

Clause 39. The method of clause 36, wherein if an input of the subsequent sub-module is an output of other sub-modules after the current sub-module, and the input of the current sub-module is exchanged, the output of the subsequent sub-module is exchanged.

Clause 40. The method of clause 36, wherein if the subsequent sub-module is a final sub-module, and the input of the current sub-module is exchanged, the output of the subsequent sub-module is exchanged.

Clause 41. The method of clause 36, wherein the exchange of the output of the subsequent sub-module is dependent on coding mode or coding statistics of the video unit.

Clause 42. The method of clause 41, wherein the coding statistics comprise at least one of: a prediction mode, QP, temporal layer, or slice type.

Clause 43. The method of clause 41, wherein the exchange of the output of the subsequent sub-module is dependent on at least one of: a prediction mode, QP, temporal layer, or slice type.

Clause 44. The method of clause 41, wherein the exchange of the output of the subsequent sub-module is dependent on a quantization step.

Clause 45. The method of clause 41, wherein the exchange of the output of the subsequent sub-module is dependent on a temporal layer.

Clause 46. The method of clause 41, wherein the exchange of the output of the subsequent sub-module is dependent on a slice type.

Clause 47. The method of clause 41, wherein the exchange of the output of the subsequent sub-module is dependent on a block size of the video unit.

Clause 48. The method of clause 41, wherein the exchange of the output of the subsequent sub-module is dependent on color components.

Clause 49. The method of clause 41, wherein the exchange of the output of the subsequent sub-module is dependent on signals in the bitstream.

Clause 50. The method of clause 49, wherein the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs.

Clause 51. The method of clause 41, wherein the exchange of the output of the subsequent sub-module is dependent on a cost of a rate distortion optimization in an encoder.

Clause 52. The method of clause 1, wherein if an input of the NN filter is exchanged, an output of the NN filter is selected or exchanged.

Clause 53. The method of clause 52, wherein input signals of the NN filter comprise I₀, I₁, I₂ and corresponding output signals of the NN filter comprise R₀, R₁, R₂, and wherein if the input signals are exchanged, the output signals of the NN filter are changed to R′₀, R′₂, R′₁.

Clause 54. The method of clause 52, wherein an output signal and a changed output signal of the NN filter with different inputs are selected.

Clause 55. The method of clause 54, wherein whether to/how to select the output signal is dependent on coding modes or coding statistics of the video unit.

Clause 56. The method of clause 52, wherein input signals of the NN filter comprise at least one of: a set of reconstructions, a set of predictions, a set of boundary strengths, or a partition of components, and wherein output signals of the NN filter comprise enhanced reconstruction of the components.

Clause 57. The method of clause 56, wherein the components comprise one component of Y, Cb, or Cr components.

Clause 58. The method of clause 56, wherein the components comprise one component of R, G, or B components.

Clause 59. The method of any of clauses 1-58, wherein whether to and/or how to select at least one of: the set of sub-modules, inputs of the set of sub-modules, or outputs of the set of sub-modules is dependent on a predefined or adaptive method.

Clause 60. The method of clause 59, wherein a sub-module for input signals of different components is selected in an encoder or decoder.

Clause 61. The method of clause 59, wherein input signals of different components are selected before being fed into the set of sub-modules in an encoder or decoder.

Clause 62. The method of clause 59, wherein output signals of the NN filter for different components are selected in an encoder or decoder.

Clause 63. The method of any of clauses 1-58, wherein whether to and/or how to select at least one of: the set of sub-modules, inputs of the set of sub-modules, or outputs of the set of sub-modules is dependent on coding modes or coding statistics of the video unit.

Clause 64. The method of clause 63, wherein the coding statistics comprise at least one of: a prediction mode, QP, temporal layer, or slice type.

Clause 65. The method of clause 63, wherein whether to and/or how to select at least one of: the set of sub-modules, inputs of the set of sub-modules, or outputs of the set of sub-modules is dependent on at least one of: a prediction mode, QP, temporal layer, or slice type.

Clause 66. The method of clause 63, wherein whether to and/or how to select at least one of: the set of sub-modules, inputs of the set of sub-modules, or outputs of the set of sub-modules is dependent on a quantization step.

Clause 67. The method of clause 63, wherein whether to and/or how to select at least one of: the set of sub-modules, inputs of the set of sub-modules, or outputs of the set of sub-modules is dependent on a temporal layer.

Clause 68. The method of clause 63, wherein whether to and/or how to select at least one of: the set of sub-modules, inputs of the set of sub-modules, or outputs of the set of sub-modules is dependent on a slice type.

Clause 69. The method of clause 63, wherein whether to and/or how to select at least one of: the set of sub-modules, inputs of the set of sub-modules, or outputs of the set of sub-modules is dependent on a block size of the video unit.

Clause 70. The method of clause 63, wherein whether to and/or how to select at least one of: the set of sub-modules, inputs of the set of sub-modules, or outputs of the set of sub-modules is dependent on color components.

Clause 71. The method of clause 63, wherein whether to and/or how to select at least one of: the set of sub-modules, inputs of the set of sub-modules, or outputs of the set of sub-modules is dependent on is dependent on signals in the bitstream.

Clause 72. The method of clause 71, wherein the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs.

Clause 73. The method of clause 63, wherein whether to and/or how to select at least one of: the set of sub-modules, inputs of the set of sub-modules, or outputs of the set of sub-modules is dependent on a cost of a rate distortion optimization in an encoder.

Clause 74. The method of any of clauses 1-58, wherein if at least one of: the set of sub-modules, inputs of the set of sub-modules, or outputs of the set of sub-modules is selected, an output of the NN filter is selected.

Clause 75. The method of clause 74, wherein whether to and/or how to select the output of the NN filter is dependent on a predefined method or adaptive method.

Clause 76. The method of clause 74, wherein whether to and/or how to select the output of the NN filter is dependent on coding modes or coding statistics of the video unit.

Clause 77. The method of clause 76, wherein the coding statistics comprise at least one of: a prediction mode, QP, temporal layer, or slice type.

Clause 78. The method of clause 74, wherein whether to and/or how to select the output of the NN filter is dependent on at least one of: a prediction mode, QP, temporal layer, or slice type.

Clause 79. The method of clause 74, wherein whether to and/or how to select the output of the NN filter is dependent on a quantization step.

Clause 80. The method of clause 74, wherein whether to and/or how to select the output of the NN filter is dependent on a temporal layer.

Clause 81. The method of clause 74, wherein whether to and/or how to select the output of the NN filter is dependent on a slice type.

Clause 82. The method of clause 74, wherein whether to and/or how to select the output of the NN filter is dependent on a block size of the video unit.

Clause 83. The method of clause 74, wherein whether to and/or how to select the output of the NN filter is dependent on color components.

Clause 84. The method of clause 74, wherein whether to and/or how to select the output of the NN filter is dependent on is dependent on signals in the bitstream.

Clause 85. The method of clause 84, wherein the signals are in one of: a sequence, a picture, a slice, a tile, a brick, a subpicture, a coding tree unit (CTU) a coding tree block (CTB), a CTU row, a CTB row, a coding unit (CU), a coding block (CB), a plurality of CUs, or a plurality of CBs.

Clause 86. The method of clause 74, wherein whether to and/or how to select the output of the NN filter is dependent on a cost of a rate distortion optimization in an encoder.

Clause 87. The method of any of clauses 1-58, whether to and/or how to select at least one of: the set of sub-modules, inputs of the set of sub-modules, or outputs of the set of sub-modules is indicated from an encoder to a decoder.

Clause 88. The method of clause 87, wherein the number of sub-module to be selected is predefined, or wherein the number of sub-models to be selected is signaled with at least one syntax element (SE).

Clause 89. The method of clause 87, wherein an index of a selected sub-module is selected with at least one SE.

Clause 90. The method of any of clauses 1-89, wherein the SE is binarized as one of a flag, a fixed length code, an EG(x) code, a unary code, a truncated unary code, or a truncated binary code.

Clause 91. The method of clause 90, wherein the SE is signed or unsigned.

Clause 92. The method of any of clauses 1-91, wherein the SE is coded with at least one context model, or wherein the SE is bypass coded.

Clause 93. The method of any of clauses 1-92, wherein the SE is signaled in a conditional way.

Clause 94. The method of clause 93, wherein the SE is signaled only if a corresponding function is applicable, or wherein the SE is signaled only if dimensions of the video unit satisfy a condition.

Clause 95. The method of any of clauses 1-94, wherein the SE is indicated at one of the followings: sequence level, group of pictures level, picture level, slice level, or tile group level.

Clause 96. The method of any of clauses 1-94, wherein the SE is indicated at one of the followings: a prediction block (PB), a transform block (TB), a coding block (CB), a prediction unit (PU), a transform unit (TU), a coding unit (CU), a coding tree block (CTB), or a coding tree unit (CTU).

Clause 97. The method of any of clauses 1-96, wherein the video unit is coded with a coding tool, or wherein the video unit is excluded to be coded with the coding tool.

Clause 98. The method of clause 97, wherein the coding tool comprises one of: affine, multiple transform selection (MTS), low-frequency non-separable transform (LFNST), a merge mode with motion vector difference (MMVD), matrix weighted intra prediction (MIP), intra sub-partitions (ISP), Cross-Component Linear Model (CCLM), convolutional cross-component model (CCCM), Symmetric motion vector difference (SMVD) signalling, Bi-directional optical flow (BDOF), Decoder side motion vector refinement (DMVR), history-based motion vector prediction (HMVP), Template Matching, intra block copy (IBC), or palette.

Clause 99. The method of clause 97, wherein if the NN filter including a selectable sub-module or selectable input or output of the sub-module is applied, the coding tool is disabled implicitly without signaling, or wherein if the coding tool is used, the NN filter including a selectable sub-module or selectable input or output of the sub-module is disabled implicitly without signaling.

Clause 100. The method of any of clauses 1-99, wherein the conversion includes encoding the video unit into the bitstream.

Clause 101. The method of any of clauses 1-99, wherein the conversion includes decoding the video unit from the bitstream.

Clause 102. An apparatus for video processing comprising a processor and a non-transitory memory with instructions thereon, wherein the instructions upon execution by the processor, cause the processor to perform a method in accordance with any of clauses 1-101.

Clause 103. A non-transitory computer-readable storage medium storing instructions that cause a processor to perform a method in accordance with any of clauses 1-101.

Clause 104. A non-transitory computer-readable recording medium storing a bitstream of a video which is generated by a method performed by an apparatus for video processing, wherein the method comprises: applying a neural network (NN) filter to a video unit of the video, wherein the NN filter comprises a set of sub-modules, at least one of: the set of sub-modules, inputs of the set of sub-modules, or outputs of the set of sub-modules is selectable; and generating a bitstream of the video based on the NN filter.

Clause 105. A method for storing a bitstream of a video, comprising applying a neural network (NN) filter to a video unit of the video, wherein the NN filter comprises a set of sub-modules, at least one of: the set of sub-modules, inputs of the set of sub-modules, or outputs of the set of sub-modules is selectable; generating a bitstream of the video based on the NN filter; and storing the bitstream in a non-transitory computer-readable recording medium.

### Example Device

FIG. 19 illustrates a block diagram of a computing device 1900 in which various embodiments of the present disclosure can be implemented. The computing device 1900 may be implemented as or included in the source device 110 (or the video encoder 114 or 200) or the destination device 120 (or the video decoder 124 or 300).

It would be appreciated that the computing device 1900 shown in FIG. 19 is merely for purpose of illustration, without suggesting any limitation to the functions and scopes of the embodiments of the present disclosure in any manner.

As shown in FIG. 19, the computing device 1900 includes a general-purpose computing device 1900. The computing device 1900 may at least comprise one or more processors or processing units 1910, a memory 1920, a storage unit 1930, one or more communication units 1940, one or more input devices 1950, and one or more output devices 1960.

In some embodiments, the computing device 1900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1900 can support any type of interface to a user (such as “wearable” circuitry and the like).

The processing unit 1910 may be a physical or virtual processor and can implement various processes based on programs stored in the memory 1920. In a multi-processor system, multiple processing units execute computer executable instructions in parallel so as to improve the parallel processing capability of the computing device 1900. The processing unit 1910 may also be referred to as a central processing unit (CPU), a microprocessor, a controller or a microcontroller.

The computing device 1900 typically includes various computer storage medium. Such medium can be any medium accessible by the computing device 1900, including, but not limited to, volatile and non-volatile medium, or detachable and non-detachable medium. The memory 1920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1930 may be any detachable or non-detachable medium and may include a machine-readable medium such as a memory, flash memory drive, magnetic disk or another other media, which can be used for storing information and/or data and can be accessed in the computing device 1900.

The computing device 1900 may further include additional detachable/non-detachable, volatile/non-volatile memory medium. Although not shown in FIG. 19, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1940 communicates with a further computing device via the communication medium. In addition, the functions of the components in the computing device 1900 can be implemented by a single computing cluster or multiple computing machines that can communicate via communication connections. Therefore, the computing device 1900 can operate in a networked environment using a logical connection with one or more other servers, networked personal computers (PCs) or further general network nodes.

The input device 1950 may be one or more of a variety of input devices, such as a mouse, keyboard, tracking ball, voice-input device, and the like. The output device 1960 may be one or more of a variety of output devices, such as a display, loudspeaker, printer, and the like. By means of the communication unit 1940, the computing device 1900 can further communicate with one or more external devices (not shown) such as the storage devices and display device, with one or more devices enabling the user to interact with the computing device 1900, or any devices (such as a network card, a modem and the like) enabling the computing device 1900 to communicate with one or more other computing devices, if required. Such communication can be performed via input/output (I/O) interfaces (not shown).

In some embodiments, instead of being integrated in a single device, some or all components of the computing device 1900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1900 may be used to implement video encoding/decoding in embodiments of the present disclosure. The memory 1920 may include one or more video coding modules 1925 having one or more program instructions. These modules are accessible and executable by the processing unit 1910 to perform the functionalities of the various embodiments described herein.

In the example embodiments of performing video encoding, the input device 1950 may receive video data as an input 1970 to be encoded. The video data may be processed, for example, by the video coding module 1925, to generate an encoded bitstream. The encoded bitstream may be provided via the output device 1960 as an output 1980.

In the example embodiments of performing video decoding, the input device 1950 may receive an encoded bitstream as the input 1970. The encoded bitstream may be processed, for example, by the video coding module 1925, to generate decoded video data. The decoded video data may be provided via the output device 1960 as the output 1980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
applying, for a conversion between a video unit of a video and a bitstream of the video, a neural network (NN) filter to the video unit, wherein the NN filter comprises a set of sub-modules, at least one of: the set of sub-modules, inputs of the set of sub-modules, or outputs of the set of sub-modules is selectable; and
performing the conversion based on the NN filter.

2. The method of claim 1, wherein the NN filter is included in a decoder or encoder, and/or
wherein the NN filter is used to enhance a reconstruction of decoded pictures, and/or
wherein the NN filter is used to do up sampling on at least one of a luma reconstruction or chroma reconstruction, or
wherein the NN filter is used to super resolution, and/or
wherein additional information is involved in an input part of the NN filter, and/or
wherein a sub-module in the NN filter comprises at least one of: a head module, a backbone module, a tail module, an output layer, or a feature extraction.

3. The method of claim 2, wherein the reconstruction is generated by prediction and residual, or
wherein the reconstruction is a filtered output signal of other filters, and/or
wherein the additional information comprises at least one of: a prediction, a partition, a boundary strength, or a quantization parameter (QP) map, and/or
wherein the additional information comprises a coding mode, and/or
wherein the additional information is generated by at least one of: a reconstruction, decoded information, or a signal indicated in a bitstream, and/or
wherein the additional information is associated with at least one of: a current block, a neighboring block, or a neighboring block in a different picture, and/or
wherein signals from luma component are involved in the additional information for chroma component, and/or
wherein if the sub-module is replaced by a different sub-module, the NN filter works in a same way, and/or
wherein if an output of the sub-module is exchanged, the NN filter works in a same way, and/or
wherein if an input of the sub-module is exchanged, the NN filter works in a same way, and/or
wherein if a plurality of sub-modules is with same features or purposes, the sub-module is selected or exchanged.

4. The method of claim 3, wherein if the plurality of sub-modules is different for color components, the sub-module with same purposes designed for different color components is selected or exchanged, and/or
wherein if a plurality of sub-modules is designed for one component, the sub-module is selected or exchanged, and/or
wherein if the plurality of sub-modules is different for color components, the sub-module with same functions designed for different color components is selected or exchanged, and/or
wherein the sub-module is a feature extraction.

5. The method of claim 4, wherein if the sub-module is for an input signals of at least one of: Y component, Cb component, Cr component, R component, G component, or B component, the sub-module is selected.

6. The method of claim 1, wherein if a sub-module is a current sub-module or a subsequent sub-module after current sub-module, and the current sub-module is exchanged or replaced by another sub-module, an output of the sub-module is selected, and/or
wherein an output of a subsequent sub-module is exchanged according to a result of whether to exchange an output of a current sub-module, and/or
wherein an output of a subsequent sub-module is exchanged according to a result of whether to exchange an input of a current sub-module.

7. The method of claim 6, wherein if an input of the subsequent sub-module is the output of the current sub-module and the output of the current sub-module is exchanged, the output of the subsequent sub-module is exchanged, and/or
wherein if an input of the subsequent sub-module is an output of other sub-modules after the current sub-module, and the output of the current sub-module is exchanged, the output of the subsequent sub-module is exchanged, and/or
wherein if the subsequent sub-module is a final sub-module, and the output of the current sub-module is exchanged, the output of the subsequent sub-module is exchanged, and/or
wherein the exchange of the output of the subsequent sub-module is dependent on coding mode or coding statistics of the video unit, and/or
wherein if the sub-module is a current sub-module and an input of the current sub-module is exchanged, the output of the subsequent sub-module is exchanged, and/or
wherein if an input of the subsequent sub-module is the output of the current sub-module and the input of the current sub-module is exchanged, the output of the subsequent sub-module is exchanged, and/or
wherein if an input of the subsequent sub-module is an output of other sub-modules after the current sub-module, and the input of the current sub-module is exchanged, the output of the subsequent sub-module is exchanged, and/or
wherein if the subsequent sub-module is a final sub-module, and the input of the current sub-module is exchanged, the output of the subsequent sub-module is exchanged, and/or
wherein the exchange of the output of the subsequent sub-module is dependent on coding mode or coding statistics of the video unit.

8. The method of claim 7, wherein the coding statistics comprise at least one of: a prediction mode, QP, temporal layer, or slice type, and/or
wherein the exchange of the output of the subsequent sub-module is dependent on at least one of: a prediction mode, QP, temporal layer, or slice type, and/or
wherein the exchange of the output of the subsequent sub-module is dependent on a quantization step, and/or
wherein the exchange of the output of the subsequent sub-module is dependent on a temporal layer, and/or
wherein the exchange of the output of the subsequent sub-module is dependent on a slice type, and/or
wherein the exchange of the output of the subsequent sub-module is dependent on a block size of the video unit, and/or
wherein the exchange of the output of the subsequent sub-module is dependent on color components, and/or
wherein the exchange of the output of the subsequent sub-module is dependent on signals in the bitstream, and/or
wherein the exchange of the output of the subsequent sub-module is dependent on a cost of a rate distortion optimization in an encoder, and/or
wherein the coding statistics comprise at least one of: a prediction mode, QP, temporal layer, or slice type, and/or
wherein the exchange of the output of the subsequent sub-module is dependent on at least one of: a prediction mode, QP, temporal layer, or slice type, and/or
wherein the exchange of the output of the subsequent sub-module is dependent on a quantization step, and/or
wherein the exchange of the output of the subsequent sub-module is dependent on a temporal layer, and/or
wherein the exchange of the output of the subsequent sub-module is dependent on a slice type, and/or
wherein the exchange of the output of the subsequent sub-module is dependent on a block size of the video unit, and/or
wherein the exchange of the output of the subsequent sub-module is dependent on color components, and/or
wherein the exchange of the output of the subsequent sub-module is dependent on signals in the bitstream, and/or
wherein the exchange of the output of the subsequent sub-module is dependent on a cost of a rate distortion optimization in an encoder.

9. The method of claim 8, wherein the signals are in one of: a sequence, a picture, a slice, a tile, a brick, a subpicture, a coding tree unit (CTU), a coding tree block (CTB), a CTU row, a CTB row, a coding unit (CU), a coding block (CB), a plurality of CUs, or a plurality of CBs.

10. The method of claim 1, wherein if an input of the NN filter is exchanged, an output of the NN filter is selected or exchanged.

11. The method of claim 10, wherein input signals of the NN filter comprise I₀, I₁, I₂ and corresponding output signals of the NN filter comprise R₀, R_{I}, R₂, and
wherein if the input signals are exchanged, the output signals of the NN filter are changed to R′₀, R′₂, R′₁, and/or
wherein an output signal and a changed output signal of the NN filter with different inputs are selected, and/or
wherein input signals of the NN filter comprise at least one of: a set of reconstructions, a set of predictions, a set of boundary strengths, or a partition of components, and
wherein output signals of the NN filter comprise enhanced reconstruction of the components.

12. The method of claim 11, wherein whether to/how to select the output signal is dependent on coding modes or coding statistics of the video unit, and/or
wherein the components comprise one component of Y, Cb, or Cr components, and/or
wherein the components comprise one component of R, G, or B components.

13. The method of claim 1, wherein whether to and/or how to select at least one of: the set of sub-modules, inputs of the set of sub-modules, or outputs of the set of sub-modules is dependent on a predefined or adaptive method, and/or
wherein whether to and/or how to select at least one of: the set of sub-modules, inputs of the set of sub-modules, or outputs of the set of sub-modules is dependent on coding modes or coding statistics of the video unit, and/or
wherein if at least one of: the set of sub-modules, inputs of the set of sub-modules, or outputs of the set of sub-modules is selected, an output of the NN filter is selected, and/or
where whether to and/or how to select at least one of: the set of sub-modules, inputs of the set of sub-modules, or outputs of the set of sub-modules is indicated from an encoder to a decoder.

14. The method of claim 13, wherein a sub-module for input signals of different components is selected in an encoder or decoder, and/or
wherein input signals of different components are selected before being fed into the set of sub-modules in an encoder or decoder, and/or
wherein output signals of the NN filter for different components are selected in an encoder or decoder, and/or
wherein the coding statistics comprise at least one of: a prediction mode, QP, temporal layer, or slice type, and/or
wherein whether to and/or how to select at least one of: the set of sub-modules, inputs of the set of sub-modules, or outputs of the set of sub-modules is dependent on at least one of: a prediction mode, QP, temporal layer, or slice type, and/or
wherein whether to and/or how to select at least one of: the set of sub-modules, inputs of the set of sub-modules, or outputs of the set of sub-modules is dependent on a quantization step, and/or
wherein whether to and/or how to select at least one of: the set of sub-modules, inputs of the set of sub-modules, or outputs of the set of sub-modules is dependent on a temporal layer, and/or
wherein whether to and/or how to select at least one of: the set of sub-modules, inputs of the set of sub-modules, or outputs of the set of sub-modules is dependent on a slice type, and/or
wherein whether to and/or how to select at least one of: the set of sub-modules, inputs of the set of sub-modules, or outputs of the set of sub-modules is dependent on a block size of the video unit, and/or
wherein whether to and/or how to select at least one of: the set of sub-modules, inputs of the set of sub-modules, or outputs of the set of sub-modules is dependent on color components, and/or
wherein whether to and/or how to select at least one of: the set of sub-modules, inputs of the set of sub-modules, or outputs of the set of sub-modules is dependent on is dependent on signals in the bitstream, and/or
wherein whether to and/or how to select at least one of: the set of sub-modules, inputs of the set of sub-modules, or outputs of the set of sub-modules is dependent on a cost of a rate distortion optimization in an encoder, and/or
wherein whether to and/or how to select the output of the NN filter is dependent on a predefined method or adaptive method, and/or
wherein whether to and/or how to select the output of the NN filter is dependent on coding modes or coding statistics of the video unit, and/or
wherein whether to and/or how to select the output of the NN filter is dependent on at least one of: a prediction mode, QP, temporal layer, or slice type, and/or
wherein whether to and/or how to select the output of the NN filter is dependent on a quantization step, and/or
wherein whether to and/or how to select the output of the NN filter is dependent on a temporal layer, and/or
wherein whether to and/or how to select the output of the NN filter is dependent on a slice type, and/or
wherein whether to and/or how to select the output of the NN filter is dependent on a block size of the video unit, and/or
wherein whether to and/or how to select the output of the NN filter is dependent on color components, and/or
wherein whether to and/or how to select the output of the NN filter is dependent on is dependent on signals in the bitstream, and/or
wherein whether to and/or how to select the output of the NN filter is dependent on a cost of a rate distortion optimization in an encoder, and/or
wherein the number of sub-module to be selected is predefined, or
wherein the number of sub-models to be selected is signaled with at least one syntax element (SE), and/or
wherein an index of a selected sub-module is selected with at least one SE.

15. The method of claim 14, wherein the signals are in one of: a sequence, a picture, a slice, a tile, a brick, a subpicture, a coding tree unit (CTU), a coding tree block (CTB), a CTU row, a CTB row, a coding unit (CU), a coding block (CB), a plurality of CUs, or a plurality of CBs, and/or
wherein the coding statistics comprise at least one of: a prediction mode, QP, temporal layer, or slice type.

16. The method of claim 1, wherein the conversion includes encoding the video unit into the bitstream.

17. The method of claim 1, wherein the conversion includes decoding the video unit from the bitstream.

18. An apparatus for video processing comprising a processor and a non-transitory memory with instructions thereon, wherein the instructions upon execution by the processor, cause the processor to perform a method, wherein the method comprises:
applying, for a conversion between a video unit of a video and a bitstream of the video, a neural network (NN) filter to the video unit, wherein the NN filter comprises a set of sub-modules, at least one of: the set of sub-modules, inputs of the set of sub-modules, or outputs of the set of sub-modules is selectable; and
performing the conversion based on the NN filter.

19. A non-transitory computer-readable storage medium storing instructions that cause a processor to perform a method, wherein the method comprises:
applying, for a conversion between a video unit of a video and a bitstream of the video, a neural network (NN) filter to the video unit, wherein the NN filter comprises a set of sub-modules, at least one of: the set of sub-modules, inputs of the set of sub-modules, or outputs of the set of sub-modules is selectable; and
performing the conversion based on the NN filter.

20. A non-transitory computer-readable recording medium storing a bitstream of a video which is generated by a method performed by an apparatus for video processing, wherein the method comprises:
applying a neural network (NN) filter to a video unit of the video, wherein the NN filter comprises a set of sub-modules, at least one of: the set of sub-modules, inputs of the set of sub-modules, or outputs of the set of sub-modules is selectable; and
generating the bitstream based on the NN filter.
